(19) United States
(12) Patent Application Publication
(10) Pub. No.: US 2023/0421785 A1
(43) Pub. Date: Dec. 28, 2023

(54) VIDEO CODING APPARATUS AND VIDEO DECODING APPARATUS

(71) Applicant: SHARP KABUSHIKI KAISHA, Sakai City (JP)

(72) Inventors: TAKESHI CHUJOH, Sakai City (JP); TOMOHIRO IKAI, Sakai City (JP); YUKINOBU YASUGI, Sakai City (JP); YASUAKI TOKUMO, Sakai City (JP); TOMOKO AONO, Sakai City (JP); Keiichiro TAKADA, Sakai City (JP)

(21) Appl. No.: 18/212,441

(22) Filed: Jun. 21, 2023

(30) Foreign Application Priority Data
Jun. 24, 2022 (JP) 2022-101630

(51) Int. Cl. H04N 19/33; H04N 19/182

(52) U.S. Cl. CPC H04N 19/33; H04N 19/182

(57) ABSTRACT

A video decoding apparatus includes an image decoding apparatus configured to decode coded data to generate a decoded image, and a resolution inverse conversion apparatus configured to convert a resolution of the decoded image to a specified resolution by using inverse conversion information. The resolution inverse conversion apparatus uses a neural network. In the resolution inverse conversion apparatus, information, indicating a number of horizontal pixels and a number of vertical pixels of a patch size being a unit of processing of the neural network, is decoded. The number of horizontal pixels and the number of vertical pixels of the decoded image are set equal to a maximum value of the number of horizontal pixels and a maximum value of the number of vertical pixels of the patch size, respectively.

### TECHNICAL FIELD

Embodiments of the present invention relate to a video coding apparatus and a video decoding apparatus.

### BACKGROUND ART

A video coding apparatus which generates coded data by coding a video, and a video decoding apparatus which generates decoded images by decoding the coded data are used for efficient transmission or recording of videos.

Specific video coding schemes include, for example, H.264/AVC and H.265/High-Efficiency Video Coding (HEVC) schemes.

In such a video coding scheme, images (pictures) constituting a video are managed in a hierarchical structure including slices obtained by splitting an image, coding tree units (CTUs) obtained by splitting a slice, units of coding (which may also be referred to as coding units (CUs)) obtained by splitting a coding tree unit, and transform units (TUs) obtained by splitting a coding unit, and are coded/decoded for each CU.

In such a video coding scheme, usually, a prediction image is generated based on a local decoded image that is obtained by coding/decoding an input image (a source image), and prediction errors (which may be referred to also as “difference images” or “residual images”) obtained by subtracting the prediction image from the input image are coded. Generation methods of prediction images include an inter-picture prediction (inter prediction) and an intra-picture prediction (intra prediction).

H.274 defines a Supplemental Enhancement Information SEI message for simultaneously transmitting characteristics, a display method, timings, and the like of an image together with coded data.

NPL 1 discloses a method of explicitly defining the SEI for transmitting topology and parameters of a neural network filter used as a post-filter, and a method of indirectly defining the SEI as reference information.

### CITATION LIST

### Non Patent Literature

NPL 1: S. McCarthy, T. Chujoh, M. M. Hannuksela, G. J. Sullivan and Y.-K. Wang, “Additional SEI messages for VSEI (Draft 1),” JVET-Z2006, Jun. 21, 2022.

### SUMMARY OF INVENTION

### Technical Problem

However, in the specification of neural network post-filter characteristics SEI according to NPL 1, there is a problem that a patch size larger than a picture size of a decoded image may be defined.

In the specification of neural network post-filter characteristics SEI according to NPL 1, there is a problem that a variable indicating a maximum value of a network parameter may overflow with a value of a 32-bit integer or a 64-bit integer.

### Solution to Problem

According to an aspect of the present invention, provided is a video decoding apparatus including:
an image decoding apparatus configured to decode coded data to generate a decoded image; and
a resolution inverse conversion apparatus configured to convert a resolution of the decoded image to a specified resolution by using inverse conversion information, the resolution inverse conversion apparatus using a neural network, wherein
in the resolution inverse conversion apparatus, information indicating the number of horizontal pixels and the number of vertical pixels of a patch size being a unit of processing of the neural network is decoded, and
the number of horizontal pixels and the number of vertical pixels of the decoded image are set equal to a maximum value of the number of horizontal pixels and a maximum value of the number of vertical pixels of the patch size, respectively.

According to an aspect of the present invention, provided is a video decoding apparatus including:
an image decoding apparatus configured to decode coded data to generate a decoded image; and
a resolution inverse conversion apparatus configured to convert a resolution of the decoded image to a specified resolution by using inverse conversion information, the resolution inverse conversion apparatus using a neural network, wherein
information indicating a maximum value of a network parameter of the neural network in the resolution inverse conversion apparatus is decoded, and
in deriving the maximum value of the network parameter, the maximum value is derived so as to not overflow in 32-bit integer arithmetic.

According to an aspect of the present invention, provided is a video coding apparatus including:
an image coding apparatus configured to code an image to generate coded data;
an inverse conversion information generation apparatus configured to generate inverse conversion information for inversely converting a resolution of a decoded image in a case that the coded data is decoded; and
an inverse conversion information coding apparatus configured to code the inverse conversion information as supplemental enhancement information, wherein
in the inverse conversion information coding apparatus, information indicating the number of horizontal pixels and the number of vertical pixels of a patch size being a unit of processing of a neural network is coded, and
the number of horizontal pixels and the number of vertical pixels of a coded image are set equal to a maximum value of the number of horizontal pixels and a maximum value of the number of vertical pixels of the patch size, respectively.

According to an aspect of the present invention, provided is a video coding apparatus including:
an image coding apparatus configured to code an image to generate coded data;
an inverse conversion information generation apparatus configured to generate inverse conversion information for inversely converting a resolution of a decoded image in a case that the coded data is decoded; and
an inverse conversion information coding apparatus configured to code the inverse conversion information as supplemental enhancement information, wherein
information indicating a maximum value of a network parameter of a neural network in the inverse conversion information coding apparatus is coded, and
in deriving the maximum value of the network parameter, the maximum value is derived so as to not overflow in 64-bit integer arithmetic.

### Advantageous Effects of Invention

By employing the configuration as described above, processing of a neural network can be performed with efficiency and accuracy.

### BRIEF DESCRIPTION OF DRAWINGS

FIG. 1 is a schematic diagram illustrating a configuration of a video transmission system according to the present embodiment.

FIG. 2 is a diagram illustrating a hierarchical structure of coded data.

FIG. 3 is a conceptual diagram of an image to be processed in the video transmission system according to the present embodiment.

FIG. 4 is a conceptual diagram illustrating an example of a reference picture and reference picture lists.

FIG. 5 is a schematic diagram illustrating a configuration of an image decoding apparatus.

FIG. 6 is a flowchart illustrating general operation of the image decoding apparatus.

FIG. 7 is a block diagram illustrating a configuration of an image coding apparatus.

FIG. 8 is a schematic diagram illustrating a configuration of an inter prediction parameter coder.

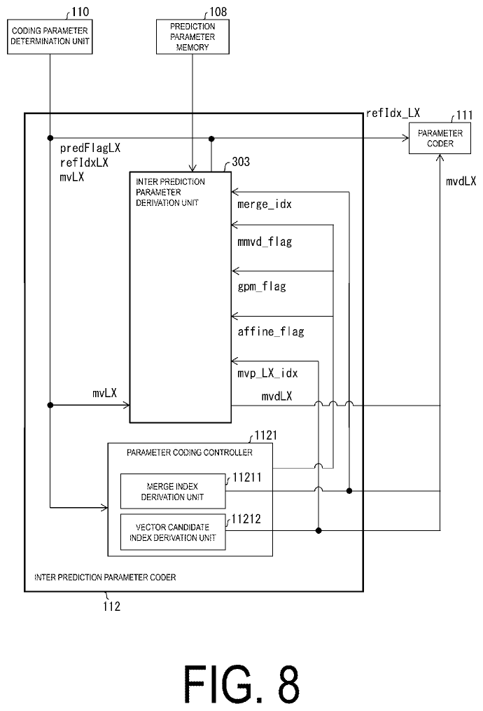

FIG. 9 is a diagram illustrating neural network post-filter characteristics SEI syntax.

FIG. 10 is a diagram illustrating syntax of a neural network complexity element.

FIG. 11 is a diagram illustrating Expression 1 of a function Reflect(y, z).

FIG. 12 is a diagram illustrating neural network post-filter activation SEI syntax.

FIG. 13 is a diagram illustrating syntax of an SEI payload being a container of an SEI message.

FIG. 14 is a diagram illustrating a flowchart of processing of an NN filter unit 611.

FIGS. 15A, 15B and 15C are diagrams illustrating a configuration of a neural network of the NN filter unit 611.

FIG. 16 is a diagram illustrating a coding apparatus and a decoding apparatus of NNR.

### DESCRIPTION OF EMBODIMENTS

### First Embodiment

Hereinafter, an embodiment of the present invention will be described with reference to the drawings.

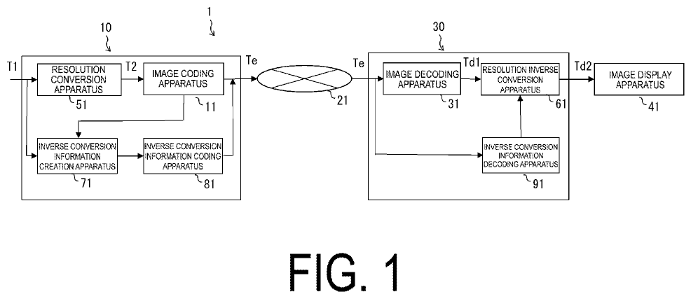

FIG. 1 is a schematic diagram illustrating a configuration of a video transmission system according to the present embodiment.

A video transmission system 1 is a system for transmitting coded data in which an image of different resolution converted in resolution is coded, decoding the coded data transmitted, and inversely transforming the coded data decoded into the image with the original resolution for display. The video transmission system 1 includes a video coding apparatus 10, a network 21, a video decoding apparatus 30, and an image display apparatus 41.

The video coding apparatus 10 includes a resolution conversion apparatus (resolution converter) 51, an image coding apparatus (image coder) 11, an inverse conversion information creation apparatus (inverse conversion information creation unit) 71, and an inverse conversion information coding apparatus (inverse conversion information coder) 81.

The video decoding apparatus 30 includes an image decoding apparatus (image decoder) 31, a resolution inverse conversion apparatus (resolution inverse converter) 61, and an inverse conversion information decoding apparatus (inverse conversion information decoder) 91.

The resolution conversion apparatus 51 converts the resolution of an image T1 included in a video, and supplies a variable resolution video T2 including the image with a different resolution to the image coding apparatus 11. The resolution conversion apparatus 51 supplies, to the image coding apparatus 11, inverse conversion information indicating the presence or absence of resolution conversion of the image. In a case that the information indicates resolution conversion, the image coding apparatus 11 sets resolution conversion information ref pic_resampling_enabled_flag to be described later equal to 1, and includes the information in a sequence parameter set SPS of coded data Te for coding.

The inverse conversion information generation apparatus 71 generates the inverse conversion information, based on the image T1 included in the video. The inverse conversion information is derived or selected from a relationship between the input image T1 before being subjected to resolution conversion and an image Td1 after being subjected to resolution conversion, coding, and decoding.

The inverse conversion information is input to the inverse conversion information coding apparatus 81. The inverse conversion information coding apparatus 81 codes the inverse conversion information to generate coded inverse conversion information, and transmits the coded inverse conversion information to the network 21.

The variable resolution image T2 is input to the image coding apparatus 11. With use of a framework of Reference Picture Resampling (RPR), the image coding apparatus 11 codes image size information of an input image for each PPS, and transmits the coded image size information to the image decoding apparatus 31.

In FIG. 1, although the inverse conversion information coding apparatus 81 is not connected with the image coding apparatus 11, the inverse conversion information coding apparatus 81 and the image coding apparatus 11 may communicate necessary information as appropriate.

The network 21 transmits the coded inverse conversion information and the coded data Te to the image decoding apparatus 31. A part or all of the coded inverse conversion information may be included in the coded data Te as supplemental enhancement information SEI. The network 21 is the Internet, a Wide Area Network (WAN), a Local Area Network (LAN), or a combination thereof. The network 21 is not necessarily limited to a bi-directional communication network, and may be a uni-directional communication network configured to transmit broadcast waves of digital terrestrial television broadcasting, satellite broadcasting, or the like. The network 21 may be substituted by a storage medium in which the coded data Te is recorded, such as a Digital Versatile Disc (DVD: trade name) or a Blue-ray Disc (BD: trade name).

The image decoding apparatus 31 decodes the coded data Te transmitted by the network 21 and generates and supplies a variable resolution decoded image Td1 to the resolution inverse conversion apparatus 61.

The inverse conversion information decoding apparatus 91 decodes the coded inverse conversion information transmitted by the network 21 and generates and supplies the inverse conversion information to the resolution inverse conversion apparatus 61.

In FIG. 1, the inverse conversion information decoding apparatus 91 is illustrated separately from the image decoding apparatus 31, however, the inverse conversion information decoding apparatus 91 may be included in the image decoding apparatus 31. For example, the inverse conversion information decoding apparatus 91 may be included in the image decoding apparatus 31 separately from each function unit of the image decoding apparatus 31. In FIG. 1, although there is no connection with the image decoding apparatus 31, the inverse conversion information decoding apparatus 91 and the image decoding apparatus 31 may communicate necessary information as appropriate.

In a case that the resolution conversion information indicates resolution conversion, the resolution inverse conversion apparatus 61 inversely transforms the decoded image of the image decoding apparatus 31 into an image having converted resolution, based on the coded data and the image size information included in the inverse conversion information. Examples of a method of inversely transforming the image having converted resolution include post-filtering processing such as super-resolution processing using a neural network.

In a case that the resolution conversion information indicates resolution of an actual size, the resolution inverse conversion apparatus 61 may perform post-filtering processing using a neural network, perform resolution inverse conversion processing of reconstructing the input image T1, and generate a decoded image Td2.

The image display apparatus 41 displays all or a part of one or multiple decoded images Td2 input from the resolution inverse conversion apparatus 61. For example, the image display apparatus 41 includes a display device such as a liquid crystal display and an organic Electro-Luminescence (EL) display. Forms of the display include a stationary type, a mobile type, an HMD type, and the like. In a case that the image decoding apparatus 31 has a high processing capability, an image having high image quality is displayed. In a case that the image decoding apparatus 31 has only a lower processing capability, an image which does not require high processing capability or display capability is displayed.

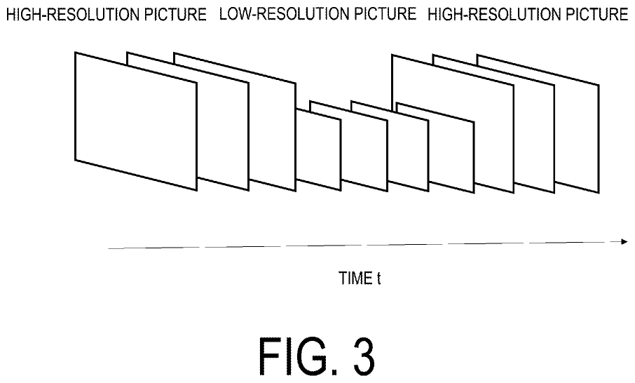

FIG. 3 is a conceptual diagram of an image to be processed in the video transmission system illustrated in FIG. 1, with a change in resolution of the image over time illustrated. Note that, FIG. 3 does not distinguish whether the image is coded. FIG. 3 illustrates an example in which, during the processing process of the video transmission system, an image with the resolution reduced is transmitted to the image decoding apparatus 31. As illustrated in FIG. 3, typically, the resolution conversion apparatus 51 performs conversion for making resolution of an image equal to or lower than resolution of an input image to decrease the amount of information to be transmitted.

### Operator

Operators used in the present specification will be described below.

» is a right bit shift, « is a left bit shift, & is a bitwise AND, | is a bitwise OR, μ= is an OR assignment operator, and ∥ indicates a logical sum.

x ? y : z is a ternary operator that takes y in a case that x is true (other than 0) and takes z in a case that x is false (0).

Clip3(a, b, c) is a function to clip c in a value of a to b, and a function to return a in a case that c is smaller than a (c<a), return b in a case that c is greater than b (c>b), and return c in the other cases (provided that a is less than or equal to b (a<=b)).

abs (a) is a function that returns the absolute value of a.

Int (a) is a function that returns the integer value of a.

floor (a) is a function that returns the maximum integer equal to or smaller than a.

ceil (a) is a function that returns the minimum integer equal to or greater than a.

a/d represents division of a by d (round down decimal places).

a^b represents power(a, b). In a case that a=2, 1«b.

### Structure of Coded Data Te

Prior to the detailed description of the image coding apparatus 11 and the image decoding apparatus 31 according to the present embodiment, a data structure of the coded data Te generated by the image coding apparatus 11 and decoded by the image decoding apparatus 31 will be described.

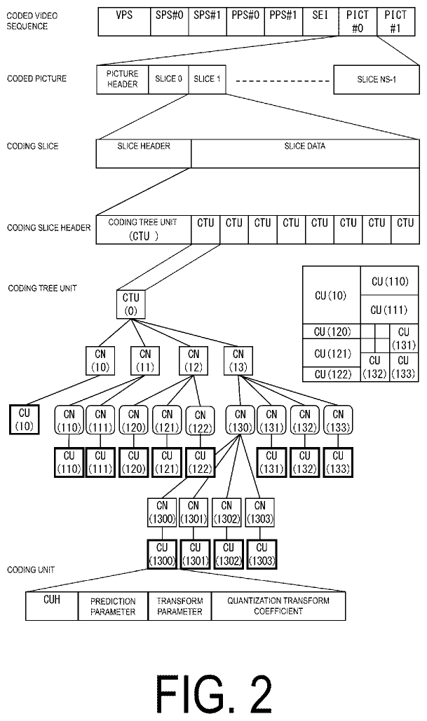

FIG. 2 is a diagram illustrating a hierarchical structure of data in the coded data Te. The coded data Te includes a sequence and multiple pictures constituting the sequence illustratively. FIG. 2 is a diagram illustrating a coded video sequence defining a sequence SEQ, a coded picture defining a picture PICT, a coding slice defining a slice S, a coding slice data defining slice data, a coding tree unit included in the coding slice data, and a coding unit included in the coding tree unit.

### Coded Video Sequence

In the coded video sequence, a set of data referred to by the image decoding apparatus 31 to decode the sequence SEQ to be processed is defined. As illustrated in FIG. 2, the sequence SEQ includes a Video Parameter Set VPS, a Sequence Parameter Set SPS, a Picture Parameter Set PPS, an Adaptation Parameter Set (APS), a picture PICT, and Supplemental Enhancement Information SEI.

In the video parameter set VPS, in a video including multiple layers, a set of coding parameters common to multiple videos and a set of coding parameters associated with the multiple layers and an individual layer included in the video are defined.

In the sequence parameter set SPS, a set of coding parameters referred to by the image decoding apparatus 31 to decode a target sequence is defined. For example, a width and a height of a picture are defined. Note that multiple SPSs may exist. In that case, any of the multiple SPSs is selected from the PPS.

Here, the sequence parameter set SPS includes the following syntax elements.
ref_pic_resampling_enabled_flag: A flag specifying whether to use a function of making the resolution variable (resampling) in a case of decoding images included in a single sequence referencing a target SPS. From another aspect, the flag indicates that the size of the reference picture referred to in the generation of the prediction image changes between the images indicated by the single sequence. In a case that the value of the flag is 1, the above resampling is applied, and in a case that the value is 0, the resampling is not applied.
pic_width_max_in_luma_samples: A syntax element indicating, in units of luma blocks, the width of an image having the largest width among images in a single sequence. The syntax element is required to have a value that is not 0 and that is an integer multiple of Max(8, MinCbSizeY). Here, MinCbSizeY is a value determined by the minimum size of the luma block.
pic_height_max_in_luma_samples: A syntax element indicating, in units of luma blocks, the height of an image having the largest height among images in a single sequence. The syntax element is required to have a value that is not 0 and that is an integer multiple of Max(8, MinCbSizeY).

In the picture parameter set PPS, a set of coding parameters referred to by the image decoding apparatus 31 to decode each picture in a target sequence is defined. Note that multiple PPSs may exist. In that case, any of the multiple PPSs is selected from each picture in a target sequence.

Here, the picture parameter set PPS includes the following syntax elements.
pps_pic_width_in_luma_samples: A syntax element indicating the width of a target picture. The syntax element is required to have a value that is not 0, that is an integer multiple of Max(8, MinCbSizeY), and that is equal to or smaller than sps_pic_width_max_in_luma_samples.
pps_pic_height_in_luma_samples: A syntax element indicating the height of the target picture. The syntax element is required to have a value that is not 0, that is an integer multiple of Max(8, MinCbSizeY), and that is equal to or smaller than sps_pic_height_max_in_luma_samples.
pps_conformance_window_flag: A flag indicating whether a conformance (cropping) window offset parameter is subsequently signaled, the flag indicating a location where a conformance window is displayed. In a case that the flag is 1, it is indicated that the parameter is signaled, and in a case that the flag is 0, it is indicated that no conformance window offset parameter is present.
pps_conf win_left_offset, pps_conf win_right_offset, pps_conf win_top_offset, pps_conf win_bottom_offset: An offset value indicating, for a rectangular region indicated in picture coordinates for output, the left, right, top, and bottom positions of a picture output in decoding processing. In a case that the value of pps_conformance_window_flag is 0, the values of pps_conf win_left_offset, pps_conf win_right_offset, pps_conf win_top_offset, and pps_conf win_bottom_offset are inferred to be 0.

Here, a variable ChromaFormatIdc of a chroma format is a value of sps_chroma_format_id. A variable SubWidthC and a variable SubHightC are values determined by ChromaFormatIdc. In a case of a monochrome format, SubWidthC and SubHightC are both 1. In a case of a 4:2:0 format, SubWidthC and SubHightC are both 2. In a case of a 4:2:2 format, SubWidthC is 2 and SubHightC is 1. In a case of a 4:4:4 format, SubWidthC and SubHightC are both 1.
pps_init_qp_minus26 is information for deriving a quantization parameter SliceQpY of a slice referred to in the PPS.

### Sub-Picture

A picture may be further split into sub-pictures, each of the sub-pictures having a rectangular shape. The size of each sub-picture may be a multiple of that of the CTU. The sub-picture is defined by a set of an integer number of vertically and horizontally consecutive tiles. In other words, a picture is split into rectangular tiles, and a set of the rectangular tiles defines the sub-picture. The sub-picture may be defined using an ID of a top left tile and an ID of a bottom right tile of the sub-picture.

### Coded Picture

In the coded picture, a set of data referred to by the image decoding apparatus 31 to decode the picture PICT to be processed is defined. As illustrated in FIG. 2, the picture PICT includes a picture header PH and slices 0 to NS−1 (NS is the total number of slices included in the picture PICT).

Information (ph_qp_delta) for deriving the quantization parameter SliceQpY updated at a picture level is further included.

SliceQpY=26+pps_init_qp_minus26+ph_qp_delta

In the description below, in a case that the slices 0 to NS−1 need not be distinguished from one another, subscripts of reference signs may be omitted. The same applies to other data with subscripts included in the coded data Te which will be described below.

### Coding Slice

In the coding slice, a set of data referred to by the image decoding apparatus 31 to decode the slice S to be processed is defined. As illustrated in FIG. 2, the slice includes a slice header and slice data.

The slice header includes a coding parameter group referred to by the image decoding apparatus 31 to determine a decoding method for a target slice. Slice type indication information (slice_type) indicating a slice type is one example of a coding parameter included in the slice header.

Examples of slice types that can be indicated by the slice type indication information include (1) I slices for which only an intra prediction is used in coding, (2) P slices for which a uni-prediction (L0 prediction) or an intra prediction is used in coding, and (3) B slices for which a uni-prediction (L0 prediction or L1 prediction), a bi-prediction, or an intra prediction is used in coding. Note that the inter prediction is not limited to the uni-prediction and the bi-prediction, and a prediction image may be generated by using a larger number of reference pictures. Hereinafter, in a case of being referred to as the P or B slice, a slice that includes a block in which the inter prediction can be used is indicated.

Information (sh_qp_delta) for deriving the quantization parameter SliceQpY updated at a slice level is further included.

SliceQpY=26+pps_init_qp_minus26+sh_qp_delta

Note that the slice header may include a reference to the picture parameter set PPS (pic_parameter_set_id).

### Coding Slice Data

In the coding slice data, a set of data referred to by the image decoding apparatus 31 to decode the slice data to be processed is defined. The slice data includes CTUs as illustrated in the coding slice header in FIG. 2. The CTU is a block of a fixed size (for example, 64×64) constituting a slice, and may be referred to as a Largest Coding Unit (LCU).

### Coding Tree Unit

In FIG. 2, a set of data referred to by the image decoding apparatus 31 to decode the CTU to be processed is defined. The CTU is split into coding units CU, each of which is a basic unit of coding processing, by a recursive Quad Tree split (QT split), Binary Tree split (BT split), or Ternary Tree split (TT split). The BT split and the TT split are collectively referred to as a Multi Tree split (MT split). Nodes of tree structure obtained by the recursive quad tree split are referred to as Coding Nodes. Intermediate nodes of a quad tree, a binary tree, and a ternary tree are coding nodes, and the CTU itself is also defined as the highest coding node.

### Coding Unit

In FIG. 2, a set of data referred to by the image decoding apparatus 31 to decode the coding unit to be processed is defined. Specifically, the CU includes a CU header CUH, a prediction parameter, a transform parameter, a quantization transform coefficient, and the like. In the CU header, a prediction mode and the like are defined.

There are cases that prediction processing is performed in units of CU or performed in units of sub-CU in which the CU is further split.

There are two types of predictions (prediction modes), which are intra prediction and inter prediction. The intra prediction refers to a prediction in an identical picture, and the inter prediction refers to prediction processing performed between different pictures (for example, between pictures of different display times, and between pictures of different layer images).

Transform and quantization processing is performed in units of CU, but the quantization transform coefficient may be subjected to entropy coding in units of subblock such as 4×4.

### Prediction Parameter

A prediction image is derived by prediction parameters accompanying a block. The prediction parameters include prediction parameters for intra prediction and inter prediction.

The prediction parameters for inter prediction will be described below. The inter prediction parameters include prediction list utilization flags predFlagL0 and predFlagL1, reference picture indices refldxL0 and refldxL1, and motion vectors mvL0 and myL1. predFlagL0 and predFlagL1 are flags indicating whether reference picture lists (L0 list and L1 list) are used, and in a case that the value of each of the flags is 1, a corresponding reference picture list is used. Note that, in a case that the present specification mentions “a flag indicating whether or not XX”, the flag being other than 0 (for example, 1) assumes a case of XX, the flag being 0 assumes a case of not XX, and 1 is treated as true and 0 is treated as false in a logical negation, a logical product, and the like (hereinafter, the same is applied). Note that other values can be used for true values and false values in real apparatuses and methods.

### Reference Picture List

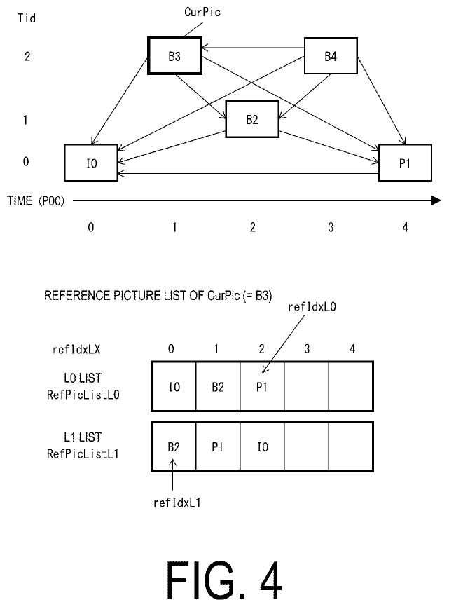

A reference picture list is a list including reference pictures stored in a reference picture memory 306. FIG. 4 is a conceptual diagram illustrating an example of a reference picture and reference picture lists. In FIG. 4 corresponding to a conceptual diagram illustrating an example of reference pictures, rectangles indicate pictures, arrows indicate reference relationships among the pictures, a horizontal axis indicates time, I, P, and B in the rectangles respectively indicate an intra-picture, a uni-prediction picture, and a bi-prediction picture, and numbers in the rectangles indicate a decoding order. Tid is a value of a Temporal ID representing depth of the hierarchy, and is transmitted in the NAL unit header. As illustrated, the decoding order of the pictures is I0, P1, B2, B3, and B4, and the display order is I0, B3, B2, B4, and P1. FIG. 4 illustrates an example of the reference picture lists of the picture B3 (target picture). Each reference picture list is a list to represent candidates of a reference picture, and one picture (slice) may include one or more reference picture lists. In the illustrated example, the target picture B3 includes two reference picture lists, i.e., an L0 list RefPicList0 and an L1 list RefPicList1. For individual CUs, which picture in a reference picture list RefPicListX (X=0 or 1) is actually referred to is indicated by refIdxLX. The diagram illustrates an example of refIdxL0=2 and refIdxL1=0. Note that LX is a description method used in a case that an L0 prediction and an L1 prediction are not distinguished, and that, in the following description, parameters for the L0 list and parameters for the L1 list are distinguished by replacing LX with L0 and L1.

### Configuration of Image Decoding Apparatus

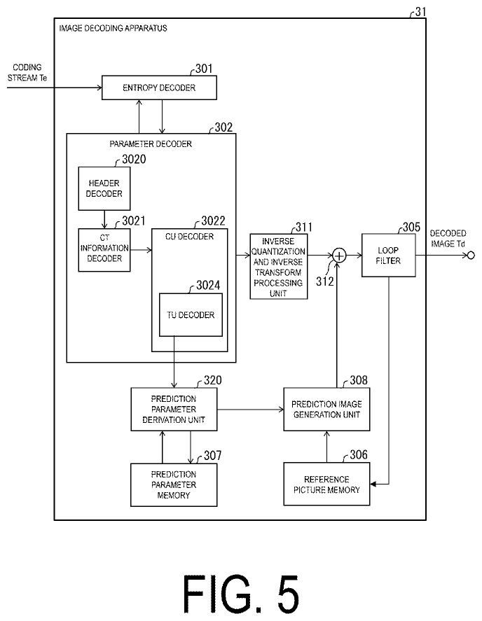

A configuration of the image decoding apparatus 31 (FIG. 5) according to the present embodiment will be described.

The image decoding apparatus 31 includes an entropy decoder 301, a parameter decoder (a prediction image decoding apparatus) 302, a loop filter 305, a reference picture memory 306, a prediction parameter memory 307, a prediction image generation unit (prediction image generation apparatus) 308, an inverse quantization and inverse transform processing unit 311, an addition unit 312, and a prediction parameter derivation unit 320. Note that a configuration in which the loop filter 305 is not included in the image decoding apparatus 31 may be used in accordance with the image coding apparatus 11 described later.

The parameter decoder 302 further includes a header decoder 3020, a CT information decoder 3021, and a CU decoder 3022 (prediction mode decoder), and the CU decoder 3022 further includes a TU decoder 3024. These may be collectively referred to as a decoding module. The header decoder 3020 decodes, from coded data, parameter set information such as the VPS, the SPS, the PPS, and the APS, and a slice header (slice information). The CT information decoder 3021 decodes a CT from coded data. The CU decoder 3022 decodes a CU from coded data.

In the mode other than a skip mode (skip_mode==0), the TU decoder 3024 decodes QP update information and quantization prediction error from coded data.

The prediction image generation unit 308 includes an inter prediction image generation unit 309 and an intra prediction image generation unit 310.

The prediction parameter derivation unit 320 includes an inter prediction parameter derivation unit 303 and an intra prediction parameter derivation unit 304.

The entropy decoder 301 performs entropy decoding on the coded data Te input from the outside and decodes individual codes (syntax elements). The entropy coding includes a scheme in which syntax elements are subjected to variable-length coding by using a context (probability model) that is adaptively selected according to a type of the syntax elements and a surrounding condition, and a scheme in which syntax elements are subjected to variable-length coding by using a table or a calculation expression that is determined in advance. The former Context Adaptive Binary Arithmetic Coding (CABAC) stores in memory a CABAC state of the context (the type of a dominant symbol (0 or 1) and a probability state index pStateIdx indicating a probability). The entropy decoder 301 initializes all CABAC states at the beginning of a segment (tile, CTU row, or slice). The entropy decoder 301 transforms the syntax element into a binary string (Bin String) and decodes each bit of the Bin String. In a case that the context is used, a context index ctxInc is derived for each bit of the syntax element, the bit is decoded using the context, and the CAB AC state of the context used is updated. Bits that do not use the context are decoded at an equal probability (EP, bypass), and the ctxInc derivation and the CABAC state are omitted. The decoded syntax element includes prediction information for generating a prediction image, a prediction error for generating a difference image, and the like.

The entropy decoder 301 outputs the decoded codes to the parameter decoder 302. Which code is to be decoded is controlled based on an indication of the parameter decoder 302.

### Basic Flow

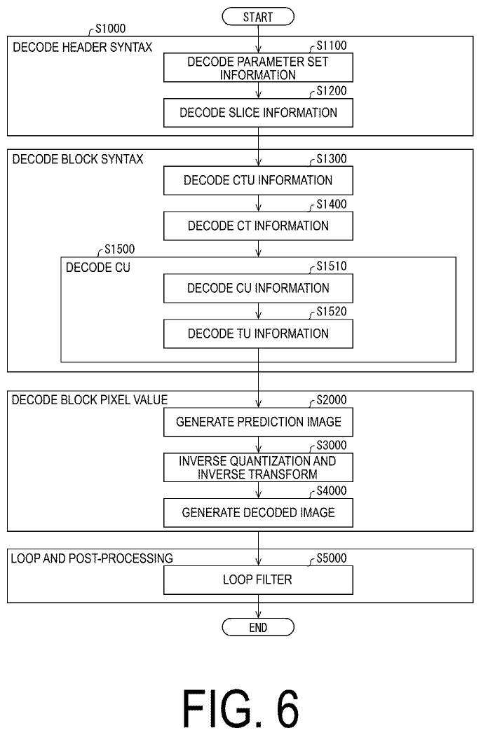

FIG. 6 is a flowchart illustrating general operation of the image decoding apparatus 31.

(S1100: Decoding of parameter set information) The header decoder 3020 decodes parameter set information such as the VPS, the SPS, and the PPS from coded data.

(S1200: Decoding of slice information) The header decoder 3020 decodes a slice header (slice information) from the coded data.

Afterwards, the image decoding apparatus 31 repeats the processing from S1300 to S5000 for each CTU included in the target picture, and thereby derives a decoded image of each CTU.

(S1300: Decoding of CTU information) The CT information decoder 3021 decodes the CTU from the coded data.

(S1400: Decoding of CT information) The CT information decoder 3021 decodes the CT from the coded data.

(S1500: Decoding of CU) The CU decoder 3022 performs S1510 and S1520 to thereby decode the CU from the coded data.

(S1510: Decoding of CU information) The CU decoder 3022 decodes CU information, prediction information, and the like from the coded data.

(S1520: Decoding of TU information) In a case that a prediction error is included in the TU, the TU decoder 3024 decodes QP update information and a quantization prediction error from the coded data. Note that the QP update information is a difference value from a quantization parameter prediction value qPpred, which is a prediction value of a quantization parameter QP.

(S2000: Generation of prediction image) The prediction image generation unit 308 generates a prediction image, based on the prediction information, for each block included in the target CU.

(S3000: Inverse quantization and inverse transform) The inverse quantization and inverse transform processing unit 311 performs inverse quantization and inverse transform processing on each TU included in the target CU.

(S4000: Generation of decoded image) The addition unit 312 generates a decoded image of the target CU by adding the prediction image supplied by the prediction image generation unit 308 and the prediction error supplied by the inverse quantization and inverse transform processing unit 311.

(S5000: Loop filter) The loop filter 305 generates a decoded image by applying a loop filter such as a deblocking filter, an SAO, and an ALF to the decoded image.

### Configuration of Inter Prediction Parameter Derivation Unit

The loop filter 305 is a filter provided in the coding loop, and is a filter that removes block distortion and ringing distortion and improves image quality. The loop filter 305 applies a filter such as a deblocking filter, a sample adaptive offset (SAO), and an adaptive loop filter (ALF) on the decoded image of the CU generated by the addition unit 312.

A DF unit 601 includes a bS derivation unit 602 that derives strength bS of the deblocking filter for each pixel, boundary, and line segment, and a DF filter unit 602 that performs deblocking filtering processing for reducing block noise.

The DF unit 601 derives an edge level edgeIdc indicating whether there is a partition split boundary, a prediction block boundary, and a transform block boundary in an input image resPicture before Neural Network (NN) processing (processing of the NN filter unit 611) and a maximum filter length maxFilterLength of the deblocking filter. The DF unit 601 further derives the strength bS of the deblocking filter from edgeIdc, the transform block boundary, and the coding parameters.

The reference picture memory 306 stores a decoded image of the CU in a predetermined position for each target picture and target CU.

The prediction parameter memory 307 stores the prediction parameter in a predetermined position for each CTU or CU.

Parameters derived by the prediction parameter derivation unit 320 are input to the prediction image generation unit 308. The prediction image generation unit 308 reads a reference picture from the reference picture memory 306. The prediction image generation unit 308 generates a prediction image of a block by using the parameters and the reference picture (reference picture block).

The inverse quantization and inverse transform processing unit 311 (residual decoder) performs inverse quantization and inverse transform on a quantization transform coefficient input from the parameter decoder 302 to calculate a transform coefficient.

### Neural Network Post-Filter Characteristics SEI

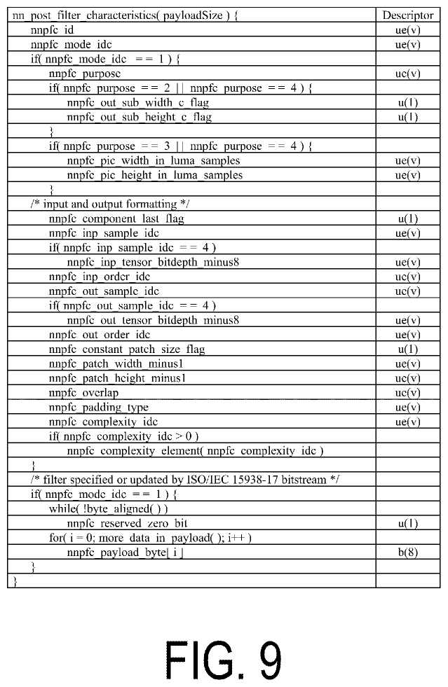

FIG. 9 illustrates syntax of a neural network post-filter characteristics SEI message nn_post_filter_characteristics (payloadSize) according to NPL 1. payloadSize being an argument represents the number of bytes of the SEI message.

The SEI message is SEI applied to each Coded Video Sequence (CVS). Note that the CVS refers to a set of 0 or more access units starting with a randomly accessible access unit such as Intra Random Access Pictures (IRAP) or Gradual Decoder Refresh Picture (GDR). The access unit includes pictures displayed at the same time. IRAP may be any one of Instantaneous Decoder Refresh (IDR), Clean Random Access (CRA), and Broken Link Access (BLA).

In the SEI message, the following variables are defined.

The width and the height of a decoded image are herein indicated by InpPicWidthInLumaSamples and InpPicHeightInLumaSamples, respectively, for each luma pixel.

InpPicWidthInLumaSamples is set equal to pps_pic_width_in_luma_samples-SubWidthC*(pps_conf_win_left_offset+pps_conf_win_right_offset).

InpPicHeightInLumaSamples is set equal to pps_pic_height_in_luma_samples-SubHeightC*(pps_conf_win_top_offset+pps_conf_win_bottom_offset).

The decoded image has two-dimensional array CroppedYPic[y][x] of a luma pixel and two-dimensional array CroppedCbPic[y][x] and CroppedCrPic[y][x] of a chroma pixel having a vertical coordinate y and a horizontal coordinate x. Here, the coordinates (x, y) of a top left corner of the pixel array are (0, 0).

The decoded image has a luma pixel bit-depth BitDepthY. The decoded image has a chroma pixel bit-depth BitDepthC. Note that both of BitDepthY and BitDepthC are set equal to BitDepth.

A variable InpSubWidthC represents a chroma sub-sampling ratio for luminance in the horizontal direction of the decoded image, and a variable InpSubHeightC represents a chroma sub-sampling ratio for luminance in the horizontal direction of the decoded image. Note that InpSubWidthC is set equal to the variable SubWidthC of coded data. InpSubHeightC is set equal to the variable SubHeightC of coded data.

A variable SliceQPY is set equal to the quantization parameter SliceQPY of coded data updated at a slice level.

nnpfc_id includes an identification number that can be used for identifying post-filtering processing. A value of nnpfc_id is a value from 0 to two to the 32nd power−2. The value of nnpfc_id from 256 to 511 or from two to the 31st power to two to the 32nd power−2 is reserved for future use. Accordingly, a decoder ignores the value of nnpfc_id from 256 to 511 or from two to the 31st power to two to the 32nd power−2.

In a case that the value of nnpfc_mode_idc is 0, it is indicated that the associated post-filtering processing is determined by an external means not indicated in this specification.

In a case that the value of nnpfc_mode_idc and nnpfc_id is 1, it is indicated that the associated post-filtering processing is a neural network represented by the ISO/IEC 15938-17 bitstream included in the SEI message.

The value of nnpfc_mode_idc is a value from 0 to 255. The value of nnpfc_mode_idc greater than 1 is reserved for future indication, and thus is not present in a bitstream conforming to the version of this specification. A decoder conforming to the version of this specification ignores the SEI message including such a reserved value of nnpfc_mode_idc. In a case that the current Coded Layer Video Sequence (CLVS) includes a preceding neural network post-filter characteristics SEI message having the same value as the value of nnpfc_id of the SEI message in decoding order, there is nnpfc_id to which at least one of the following two conditions is applied.
The value of nnpfc_mode_idc of the SEI message is 1, and has the same content as the above neural network post-filter characteristics SEI message, but the values of nnpfc_mode_idc and nnpfc_payload_byte[i] are different in order to provide a neural network update.
This SEI message has the same content as the above neural network post-filter characteristics SEI message.

With the SEI message, post-filtering processing for the current decode picture and all subsequent decode pictures until the end of the current CLVS is performed.

nnpfc_purpose indicates the purpose of the post-filtering processing. A value of nnpfc_purpose is a value from 0 to two to the 32nd power−2. The value of nnpfc_purpose greater than 4 is reserved for future specification, and thus is not present in a bitstream conforming to the version of this specification. A decoder conforming to the version of this specification ignores the SEI message including such a reserved value of nnpfc_purpose.

In a case that the value of nnpfc_purpose is 0, it indicates unknown or undefined.

In a case that the value of nnpfc_purpose is 1, it is aimed to enhance image quality.

In a case that the value of nnpfc_purpose is 2, it indicates upsampling to the 4:2:2 chroma format or the 4:4:4 chroma format, or upsampling from the 4:2:2 chroma format to the 4:4:4 chroma format.

In a case that the value of nnpfc_purpose is 3, the width or the height of an output image decoded without changing the chroma format is increased.

In a case that the value of nnpfc_purpose is 4, the width or the height of a decoded output image is increased, and the chroma format is upsampled.

A variable outSubWidthC and a variable outSubHeightC are derived using nnpfc_out_sub_width_c_flag and nnpfc_out_sub_height_c_flag, respectively. These variables indicate a chroma sub-sampling ratio for luminance of an image generated as a result of the post-filtering processing. In a case that nnpfc_out_sub_width_c_flag and nnpfc_out_sub_height_c_flag are not present, it is inferred that both are equal to 0. In a case that nnpfc_out_sub_width_c_flag and nnpfc_out_sub_height_c_flag are present, the sum of nnpfc_out_sub_width_c_flag and nnpfc_out_sub_height_c_flag is greater than 0.

outSubWidthC=InpSubWidthC−nnpfc_out_sub_width_c_flag

outSubHeightC=InpSubHeightC−nnpfc_out_sub_height_c_flag

Requirements for bitstream conformance are that both of outSubWidthC and outSubHeightC are greater than 0.

In the specification of the neural network post-filter characteristics SEI according to NPL 1, there is a problem that a non-existing chroma format in which outSubWidthC is 1 and outSubHeightC is 2 may be defined.

In view of this, as the requirements for bitstream conformance, the following requirements are set: both of outSubWidthC and outSubHeightC are greater than 0, and the value of outSubWidthC is greater than the value of outSubHeightC.

By processing the bitstream defined as described above, the problem that a non-existing chroma format may be defined (derived in the processing) can be solved.

As another solution, as the requirements for bitstream conformance, the following requirements are set: both of outSubWidthC and outSubHeightC are greater than 0, the value of outSubWidthC is not 1, and the value of outSubHeightC is not 2.

As another solution, as the requirements for bitstream conformance, the following requirements are set: both of outSubWidthC and outSubHeightC are greater than 0, and the value of outSubWidthC is equal to or greater than the value of outSubHeightC.

A syntax element nnpfc_pic_width_in_luma_samples and a syntax element nnpfc_pic_height_in_luma_samples can respectively indicate the width and the height of a luma pixel array of the image, which can be obtained by applying the post-filtering processing identified with nnpfc_id to the decoded image. In a case that nnpfc_pic_width_in_luma_samples and nnpfc_pic_height_in_luma_samples are not present, it is inferred that nnpfc_pic_width_in_luma_samples and nnpfc_pic_height_in_luma_samples are equal to InpPicWidthInLumaSamples and InpPicHeightInLumaSamples, respectively.

In a case that a value of a syntax element nnpfc_component_last_flag is 0, it is indicated that a second dimension of an input tensor inputTensor is used for the post-filtering processing and an output tensor outputTensor generated from the post-filtering processing is used for a channel.

In a case that the value of nnpfc_component_last_flag is 1, it is indicated that a last dimension of an input tensor is used for the post-filtering processing and an output tensor outputTensor generated from the post-filtering processing is used for a channel.

A syntax element nnpfc_inp_sample_idc indicates a method of transforming a pixel value of the decoded image into an input value to the post-filtering processing. In a case that a value of nnpfc_inp_sample_idc is 0, 1, 2, or 3, the input value to the post-filtering processing is in a floating-point value format of binary16, binary32, binary64, or binary128 indicated in IEEE 754-2019, respectively, and functions InpY and InpC are indicated as follows.

InpY(x)=x÷((1«BitDepthY)−1)

InpC(x)=x÷((1«BitDepthC)−1)

In a case that the value of nnpfc_inp_sample_idc is 4, the input value to the post-filtering processing is an unsigned integer, and the functions InpY and InpC are indicated as follows.

```
shift=BitDepthY−inpTensorBitDepth
if(inpTensorBitDepth>=BitDepthY)
  InpY(x)=x<<(inpTensorBitDepth−BitDepthY)
else
  InpY(x)=Clip3(0, (1<<inpTensorBitDepth)−1,
  (x+(1<<(shift−1)))>>shift)
shift=BitDepthC−inpTensorBitDepth
if(inpTensorBitDepth>=BitDepthC)
  InpC(x)=x<<(inpTensorBitDepth−BitDepthC)
else
  InpC(x)=Clip3(0, (1<<inpTensorBitDepth)−1,
  (x+(1<<(shift−1)))>>shift)
```

A variable inpTensorBitDepth is derived from a syntax element nnpfc_inp_tensor_bitdepth_minus8 to be described later.

Note that the value of nnpfc_inp_sample_idc is a value from 0 to 255. In a case that the value of nnpfc_inp_sample_idc is greater than 4, the value is reserved for future indication, and thus is not present in a bitstream conforming to the version of this specification. A decoder conforming to the version of this specification ignores the SEI message including such a reserved value of nnpfc_inp_sample_idc.

The syntax element nnpfc_inp_tensor_bitdepth_minus8 plus 8 indicates a pixel bit-depth of a luma pixel value of an input integer tensor. A value of the variable inpTensorBitDepth is derived as follows.

inpTensorBitDepth=nnpfc_inp_tensor_bitdepth_minus8+8

As the requirements for bitstream conformance, the value of nnpfc_inp_tensor_bitdepth_minus8 is in a range of 0 to 24.

A syntax element nnpfc_inp_order_idc indicates a method of ordering pixel arrays of the decoded image as inputs to the post-filtering processing. Semantics of nnpfc_inp_order_idc in a range of 0 to 3 indicates a process of deriving the input tensor inputTensor for each value of nnpfc_inp_order_idc. From a vertical pixel coordinate cTop and a horizontal pixel coordinate cLeft, a top left pixel position of a patch of pixels included in the input tensor is indicated. In a case that the chroma format of the decoded image is not 4:2:0, the value of nnpfc_inp_order_idc cannot be set equal to 3. The value of nnpfc_inp_order_idc is a value from 0 to 255. The value of nnpfc_inp_order_idc greater than 3 is reserved for future indication, and thus is not present in a bitstream conforming to the version of this specification. A decoder conforming to the version of this specification ignores the SEI message including such a reserved value of nnpfc_inp_order_idc.

The patch refers to a rectangular array of pixels from components (luma and chroma components and the like) of the image.

In a case that a syntax element nnpfc_constant_patch_size_flag is 0, it is indicated that the post-filtering processing receives, as an input, a patch size being a positive integer multiple of the patch size indicated by nnpfc_patch_width_minus1 and nnpfc_patch_height_minus1. In a case that nnpfc_patch_width_minus1 is 1, it is indicated that the post-filtering processing receives, as an input, the patch size indicated by nnpfc_patch_height_minus1.

The syntax element nnpfc_patch_width_minus1 plus 1 indicates the number of horizontal pixels of the patch size necessary for the input to the post-filtering processing, in a case that the value of nnpfc_constant_patch_size_flag is 1. In a case that the value of nnpfc_constant_patch_size_flag is 0, any positive integer multiple of (nnpfc_patch_width_minus1+1) can be used as the number of horizontal pixels of the patch size used for the input to the post-filtering processing. The value of nnpfc_patch_width_minus1 is a value from 0 to 32766.

The syntax element nnpfc_patch_height_minus1 plus 1 indicates the number of vertical pixels of the patch size necessary for the input to the post-filtering processing, in a case that the value of nnpfc_constant_patch_size_flag is 1. In a case that the value of nnpfc_constant_patch_size_flag is 0, any positive integer multiple of (nnpfc_patch_height_minus1+1) can be used as the number of vertical pixels of the patch size used for the input to the post-filtering processing. The value of nnpfc_patch_height_minus1 is a value from 0 to 32766.

In the specification of the neural network post-filter characteristics SEI according to NPL 1, there is a problem that a patch size larger than a picture size may be defined.

In view of this, the value of nnpfc_patch_width_minus1 is set equal to a value from 0 to InpPicWidthInLumaSamples−1. The variable InpPicWidthInLumaSamples indicates the number of luma pixels regarding the width in the image to which the SEI is input. The value of nnpfc_patch_height_minus1 is set equal to a value from 0 to InpPicHeightInLumaSamples−1. The variable InpPicHeightInLumaSamples indicates the number of luma pixels regarding the height in the image to which the SEI is input.

By setting a definition of the ranges of the values of the syntax of the bitstream and performing processing thereon as described above, the problem that a patch size larger than a picture size may be defined (output in a patch size larger than a picture size) can be solved.

A syntax element nnpfc_overlap indicates the number of horizontal pixels and the number of vertical pixels for which neighboring input tensors are overlapped. The value of nnpfc_overlap is a value from 0 to 16383.

Variables inpPatchWidth, inpPatchHeight, outPatchWidth, outPatchHeight, horCScaling, verCScaling, outPatchCWidth, outPatchCHeight, and overlapSize are derived as follows.

inpPatchWidth=nnpfc_patch_width_minus1+1
inpPatchHeight=nnpfc_patch_height_minus1+1
outPatchWidth=(nnpfc_pic_width_in_luma_samples*inpPatchWidth)

/InpPicWidthInLumaSamples

outPatchHeight=(nnpfc_pic_height_in_luma_samples*inpPatchHeight)

/InpPicHeightInLumaSamples

horCScaling=InpSubWidthC/outSubWidthC
verCScaling=InpSubHeightC/outSubHeightC
outPatchCWidth=outPatchWidth*horCScaling
outPatchCHeight=outPatchHeight*verCScaling
overlapSize=nnpfc_overlap

Note that outPatchWidth*InpPicWidthInLumaSamples is equal to nnpfc_pic_width_in_luma_samples*inpPatchWidth, and that outPatchHeight*InpPicHeightInLumaSamples is equal to nnpfc_pic_height_in_luma_samples*inpPatchHeight.

A syntax element nnpfc_padding_type indicates a process of padding in a case that a pixel position out of the boundary of the decoded image is referred to.

A value of nnpfc_padding_type is a value from 0 to 15.

In a case that the value of nnpfc_padding_type is 0, a value of the pixel position out of the boundary of the decoded image is set equal to 0.

In a case that the value of nnpfc_padding_type is 1, the value of the pixel position out of the boundary of the decoded image is set equal to a value of a boundary value.

In a case that the value of nnpfc_padding_type is 2, the value of the pixel position out of the boundary of the decoded image is set equal to a mirror-reflected value with respect to the boundary value.

In order to more precisely define the value, a function InpSampleVal is defined. A function InpSampleVal(y, x, picHeight, picWidth, croppedPic) receives an input of a vertical pixel position y, a horizontal pixel position x, an image height picHeight, an image width picWidth, and a pixel array croppedPic, and returns a value of sampleVal derived as follows.

```
if(nnpfc_padding_type==0)
  if(y<0||x<0||y>=picHeight||x>=picWidth)
    sampleVal=0
  else
    sampleVal=croppedPic[y][x]
else if(nnpfc_padding_type==1)
  sampleVal=croppedPic[Clip3(0, picHeight−1, y)][Clip3(0, picWidth−1, x)]
else/*nnpfc_padding_type==2*/
  sampleVal=croppedPic[Reflect(picHeight−1, y)][Reflect(picWidth−1, x)]
```

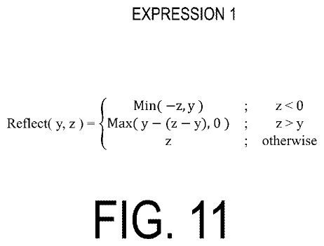

Note that a function Reflect(y, z) can be expressed as in Expression 1 of FIG. 11.

In a case that the value of nnpfc_padding_type is greater than 3, the value is reserved for future indication, and thus is not present in a bitstream conforming to the version of this specification. A decoder conforming to the version of this specification ignores the SEI message including such a reserved value of nnpfc_padding_type.

The patch refers to a rectangular array of pixels from components (luma and chroma components and the like) of the image.

In a case that a syntax element nnpfc_constant_patch_size_flag is 0, it is indicated that the post-filtering processing receives, as an input, a patch size being a positive integer multiple of the patch size indicated by nnpfc_patch_width_minus1 and nnpfc_patch_height_minus1. In a case that nnpfc_patch_width_minus1 is 1, it is indicated that the post-filtering processing receives, as an input, the patch size indicated by nnpfc_patch_height_minus1.

The syntax element nnpfc_patch_width_minus1 plus 1 indicates the number of horizontal pixels of the patch size necessary for the input to the post-filtering processing, in a case that the value of nnpfc_constant_patch_size_flag is 1. In a case that the value of nnpfc_constant_patch_size_flag is 0, any positive integer multiple of (nnpfc_patch_width_minus1+1) can be used as the number of horizontal pixels of the patch size used for the input to the post-filtering processing. The value of nnpfc_patch_width_minus1 is a value from 0 to 32766.

The syntax element nnpfc_patch_height_minus1 plus 1 indicates the number of vertical pixels of the patch size necessary for the input to the post-filtering processing, in a case that the value of nnpfc_constant_patch_size_flag is 1. In a case that the value of nnpfc_constant_patch_size_flag is 0, any positive integer multiple of (nnpfc_patch_height_minus1+1) can be used as the number of vertical pixels of the patch size used for the input to the post-filtering processing. The value of nnpfc_patch_height_minus1 is a value from 0 to 32766.

In the specification of the neural network post-filter characteristics SEI according to NPL 1, there is a problem that a patch size larger than a picture size of the decoded image may be defined.

In view of this, the value of nnpfc_patch_width_minus1 is set equal to a value from 0 to InpPicWidthInLumaSamples−1. The variable InpPicWidthInLumaSamples indicates the number of luma pixels regarding the width in the image to which the SEI is input. The value of nnpfc_patch_height_minus1 is set equal to a value from 0 to InpPicHeightInLumaSamples−1. The variable InpPicHeightInLumaSamples indicates the number of luma pixels regarding the height in the image to which the SEI is input.

By setting a definition of the ranges of the values of the syntax as described above, the problem that a patch size larger than a picture size of the decoded image may be defined can be solved.

A syntax element nnpfc_overlap indicates the number of horizontal pixels and the number of vertical pixels for which neighboring input tensors are overlapped. The value of nnpfc_overlap is a value from 0 to 16383.

Variables inpPatchWidth, inpPatchHeight, outPatchWidth, outPatchHeight, horCScaling, verCScaling, outPatchCWidth, outPatchCHeight, and overlapSize are derived as follows.

inpPatchWidth=nnpfc_patch_width_minus1+1
inpPatchHeight=nnpfc_patch_height_minus1+1
outPatchWidth=(nnpfc_pic_width_in_luma_samples*inpPatchWidth)

/InpPicWidthInLumaSamples

outPatchHeight=(nnpfc_pic_height_in_luma_samples*inpPatchHeight)

/InpPicHeightInLumaSamples

horCScaling=InpSubWidthC/outSubWidthC
verCScaling=InpSubHeightC/outSubHeightC
outPatchCWidth=outPatchWidth*horCScaling
outPatchCHeight=outPatchHeight*verCScaling
overlapSize=nnpfc_overlap

Note that outPatchWidth*InpPicWidthInLumaSamples is equal to nnpfc_pic_width_in_luma_samples * inpPatchWidth, and that outPatchHeight*InpPicHeightInLumaSamples is equal to nnpfc_pic_height_in_luma_samples*inpPatchHeight.

A syntax element nnpfc_padding_type indicates a process of padding in a case that a pixel position out of the boundary of the decoded image is referred to.

A value of nnpfc_padding_type is a value from 0 to 15.

In a case that the value of nnpfc_padding_type is 0, a value of the pixel position out of the boundary of the decoded image is set equal to 0.

In a case that the value of nnpfc_padding_type is 1, the value of the pixel position out of the boundary of the decoded image is set equal to a value of a boundary value.

In a case that the value of nnpfc_padding_type is 2, the value of the pixel position out of the boundary of the decoded image is set equal to a mirror-reflected value with respect to the boundary value. In order to more precisely define the value, a function InpSampleVal is defined. A function InpSampleVal(y, x, picHeight, picWidth, croppedPic) receives an input of a vertical pixel position y, a horizontal pixel position x, an image height picHeight, an image width picWidth, and a pixel array croppedPic, and returns a value of sampleVal derived as follows.

```
if(nnpfc_padding_type==0)
  if(y<0||x<0||y>=picHeight||x>=picWidth)
    sampleVal=0
  else
    sampleVal=croppedPic[y][x]
else if(nnpfc_padding_type==1)
  sampleVal=croppedPic[Clip3(0, picHeight−1, y)][Clip3(0, picWidth−1, x)]
else/*nnpfc_padding_type==2*/
  sampleVal=croppedPic[Reflect(picHeight−1, y)][Reflect(picWidth−1, x)]
```

Note that a function Reflect(y, z) can be expressed as in Expression 1 of FIG. 11.

In a case that the value of nnpfc_padding_type is greater than 3, the value is reserved for future indication, and thus is not present in a bitstream conforming to the version of this specification. A decoder conforming to the version of this specification ignores the SEI message including such a reserved value of nnpfc_padding_type.

In a case that the value of nnpfc_inp_order_idc is 0, only a luma matrix is present in the input tensor, and thus the number of channels is 1. A process DeriveInputTensors() for deriving the input tensor is as follows.

```
for(yP=−overlapSize;yP<inpPatchHeight+overlapSize;yP++)
  for(xP=−overlapSize;xP<inpPatchWidth+overlapSize;xP++) {
    inpVal=InpY(InpSampleVal(cTop+yP, cLeft+xP, InpPicHeightInLumaSamples,
        InpPicWidthtInLumaSamples, CroppedYPic))
    if(nnpfc_component_last_flag==0)
      inputTensor[0][0][yP÷overlapSize][xP+overlapSize]=inpVal
    else
      inputTensor[0][yP÷overlapSize][xP+overlapSize][0]=inpVal
  }
```

In a case that the value of nnpfc_inp_order_idc is 1, only a chroma matrix is present in the input tensor, and thus the number of channels is 2. The process DeriveInputTensors() for deriving the input tensor is as follows.

```
for(yP=−overlapSize;yP<inpPatchHeight+overlapSize;yP++)
  for(xP=−overlapSize;xP<inpPatchWidth+overlapSize;xP++) {
    inpCbVal=InpC(InpSampleVal(cTop+yP, cLeft+xP,
        InpPicHeightInLumaSamples/InpSubHeightC,
        InpPicWidthtInLumaSamples/InpSubWidthC, CroppedCbPic))
    inpCrVal=InpC(InpSampleVal(cTop+yP, cLeft+xP,
        InpPicHeightInLumaSamples/InpSubHeightC,
        InpPicWidthtInLumaSamples/InpSubWidthC, CroppedCrPic))
    if(nnpfc_component_last_flag==0) {
      inputTensor[0][0][yP+overlapSize][xP+overlapSize]=inpCbVal
      inputTensor[0][1][yP+overlapSize][xP+overlapSize]=inpCrVal
    }else{
      inputTensor[0][yP+overlapSize][xP+overlapSize][0]=inpCbVal
      inputTensor[0][yP+overlapSize][xP+overlapSize][1]=inpCrVal
    }
  }
```

In a case that the value of nnpfc_inp_order_idc is 2, a luma matrix and a chroma matrix are present in the input tensor, and thus the number of channels is 3. The process DeriveInputTensors() for deriving the input tensor is as follows.

```
for(yP=−overlapSize;yP<inpPatchHeight+overlapSize;yP++)
  for(xP=−overlapSize;xP<inpPatchWidth+overlapSize;xP++) {
    yY=cTop+yP
    xY=cLeft+xP
    yC=yY/InpSubHeightC
    xC=xY/InpSubWidthC
    inpYVal=InpY(InpSampleVal(yY, xY, InpPicHeightInLumaSamples,
          InpPicWidthtInLumaSamples, CroppedYPic))
    inpCbVal=InpC(InpSampleVal(yC, xC, InpPicHeightInLumaSamples/InpSubHeightC,
        InpPicWidthtInLumaSamples/InpSubWidthC, CroppedCbPic))
    inpCrVal=InpC(InpSampleVal(yC, xC, InpPicHeightInLumaSamples/InpSubHeightC,
        InpPicWidthtInLumaSamples/InpSubWidthC, CroppedCrPic))
    if(nnpfc_component_last_flag==0) {
      inputTensor[0][0][yP+overlapSize][xP+overlapSize]=inpYVal
      inputTensor[0][1][yP+overlapSize][xP+overlapSize]=inpCbVal
      inputTensor[0][2][yP+overlapSize][xP+overlapSize]=inpCrVal
    } else {
      inputTensor[0][yP+overlapSize][xP+overlapSize][0]=inpYVal
      inputTensor[0][yP+overlapSize][xP+overlapSize][1]=inpCbVal
      inputTensor[0][yP+overlapSize][xP+overlapSize][2]=inpCrVal
    }
  }
```

In a case that the value of nnpfc_inp_order_idc is 3, four luma matrices, two chroma matrices, and a quantization parameter matrix are present in the input tensor, and thus the number of channels is 7. A luma channel is derived using an interleaving method. nnpfc_inp_order_idc can be used only in a case that the chroma format is 4:2:0. In a case that nnpfc_inp_order_idc is equal to 3, the variable SliceQPY is set equal to SliceQpY of each slice. The process DeriveInputTensors() for deriving the input tensor is as follows.

```
for(yP=−overlapSize;yP<inpPatchHeight+overlapSize;yP++)
  for(xP=−overlapSize;xP<inpPatchWidth+overlapSize;xP++) {
    yTL=cTop+yP*2
    xTL=cLeft+xP*2
    yBR=yTL+1
    xBR=xTL+1
    yC=cTop/2+yP
    xC=cLeft/2+xP
    inpTLVal=InpY(InpSampleVal(yTL, xTL, InpPicHeightInLumaSamples,
        InpPicWidthtInLumaSamples, CroppedYPic))
    inpTRVal=InpY(InpSampleVal(yTL, xBR, InpPicHeightInLumaSamples,
        InpPicWidthtInLumaSamples, CroppedYPic))
    inpBLVal=InpY(InpSampleVal(yBR, xTL, InpPicHeightInLumaSamples,
        InpPicWidthtInLumaSamples, CroppedYPic))
    inpBRVal=InpY(InpSampleVal(yBR, xBR, InpPicHeightInLumaSamples,
        InpPicWidthtInLumaSamples, CroppedYPic))
    inpCbVal=InpC(InpSampleVal(yC, xC, InpPicHeightInLumaSamples/2,
        InpPicWidthtInLumaSamples/2, CroppedCbPic))
    inpCrVal=InpC(InpSampleVal(yC, xC, InpPicHeightInLumaSamples/2,
        InpPicWidthtInLumaSamples/2, CroppedCrPic))
    if(nnpfc_component_last_flag==0) {
      inputTensor[0][0][yP+overlapSize][xP+overlapSize]=inpTLVal
      inputTensor[0][1][yP+overlapSize][xP+overlapSize]=inpTRVal
      inputTensor[0][2][yP+overlapSize][xP+overlapSize]=inpBLVal
      inputTensor[0][3][yP+overlapSize][xP+overlapSize]=inpBRVal
      inputTensor[0][4][yP+overlapSize][xP+overlapSize]=inpCbVal
      inputTensor[0][5][yP+overlapSize][xP+overlapSize]=inpCrVal
      inputTensor[0][6][yP+overlapSize][xP+overlapSize]=2*(SliceQPY−42)/6
    }else{
      inputTensor[0][yP+overlapSize][xP+overlapSize][0]=inpTLVal
      inputTensor[0][yP+overlapSize][xP+overlapSize][1]=inpTRVal
      inputTensor[0][yP+overlapSize][xP+overlapSize][2]=inpBLVal
      inputTensor[0][yP+overlapSize][xP+overlapSize][3]=inpBRVal
      inputTensor[0][yP+overlapSize][xP+overlapSize][4]=inpCbVal
      inputTensor[0][yP+overlapSize][xP+overlapSize][5]=inpCrVal
      inputTensor[0][yP+overlapSize][xP+overlapSize][6]=2*(SliceQPY−42)/6
    }
  }
```

A syntax element nnpfc_complexity_idc indicates that there may be one or more syntax elements indicating complexity of the post-filtering processing associated with nnpfc_id. In a case that the value of nnpfc_complexity_idc is 0, it is indicated that there is not a syntax element indicating complexity of the post-filtering processing associated with nnpfc_id. The value of nnpfc_complexity_idc is a value from 0 to 255. In a case that the value of nnpfc_complexity_idc is greater than 1, the value is reserved for future indication, and thus is not present in a bitstream conforming to the version of this specification. A decoder conforming to the version of this specification ignores the SEI message including such a reserved value of nnpfc_complexity_idc.

A syntax element nnpfc_out_sample_idc is a value from 0 to 3, and indicates that the pixel value output as a result of the post-filtering processing is a floating-point value of binary16, binary32, binary64, or binary128 indicated in IEEE 754-2019. Functions OutY and OutC for transforming a luma pixel value and a chroma pixel value output as a result of the post-processing into integer values of pixel bit-depths are indicated as follows, using the pixel bit-depths BitDepthY and BitDepthC, respectively.

OutY(x)=Clip3(0, (1«BitDepthY)−1, Round(x*((1«BitDepthY)−1)))

OutC(x)=Clip3(0, (1«BitDepthC)−1, Round(x*((1«BitDepthC)−1)))

In a case that a value of nnpfc_out_sample_idc is 4, it is indicated that the pixel value output as a result of the post-filtering processing is an unsigned integer. The function OutY and the function OutC are indicated as follows.

```
shift=outTensorBitDepth−BitDepthY
if(outTensorBitDepth>=BitDepthY)
  OutY(x)=Clip3(0, (1<<BitDepthY)−1, (x+(1<<(shift−1)))>>shift)
else
  OutY(x)=x<<(BitDepthY−outTensorBitDepth)
shift=outTensorBitDepth−BitDepthC
if(outTensorBitDepth>=BitDepthC)
  OutC(x)=Clip3(0, (1<<BitDepthC)−1, (x+(1<<(shift−1)))>>shift)
else
  OutC(x)=x<<(BitDepthC−outTensorBitDepth)
```

In the specification of the neural network post-filter characteristics SEI according to NPL 1, with the above expression, there is a problem that a negative shift operation may be caused in a case of outTensorBitDepth==BitDepthY and in a case of outTensorBitDepth BitDepthC.

In view of this, the following expression is used for derivation. As shown below, a right shift operation is performed in a case that a variable shift is greater than 0, and thus the problem can be solved.

```
shift=outTensorBitDepth−BitDepthY
if(shift>0)
  OutY(x)=Clip3(0, (1<<BitDepthY)−1, (x+(1<<(shift−1)))>>shift)
else
  OutY(x)=x<<(BitDepthY−outTensorBitDepth)
shift=outTensorBitDepth−BitDepthC
if(shift>0)
  OutC(x)=Clip3(0, (1<<BitDepthC)−1, (x+(1<<(shift−1)))>>shift)
else
  OutC(x)=x<<(BitDepthC−outTensorBitDepth)
```

Note that the variable outTensorBitDepth is derived from a syntax element nnpfc_out_tensor_bitdepth_minus8 to be described later.

The value of nnpfc_out_sample_idc is in a range of 0 to 255. The value of nnpfc_out_sample_idc greater than 4 is reserved for future indication, and thus is not present in a bitstream conforming to the version of this specification. A decoder conforming to the version of this specification ignores the SEI message including such a reserved value of nnpfc_out_sample_idc.

Note that the indicated values of nnpfc_inp_sample_idc and nnpfc_out_sample_idc indicate that a first dimension of each of the input tensor and the output tensor is used for a batch index, which is implemented in some of neural network frameworks. Although semantics of the SEI message uses a batch size being equal to 1, determination of the batch size used as an input to inference in a neural network depends on implementation of the post-processing.

nnpfc_out_tensor_bitdepth_minus8+8 indicates the pixel bit-depth of the pixel value of an output integer tensor. A value of outTensorBitDepth is derived as follows.

outTensorBitDepth=nnpfc_out_tensor_bitdepth_minus8+8

Note that a value of nnpfc_out_tensor_bitdepth_minus8 is in a range of 0 to 24.

nnpfc_out_order_idc defines order of outputting pixels obtained as a result of the post-filtering processing. Semantics of nnpfc_out_order_idc having a value from 0 to 3 is defined.

FilteredYPic, FilteredCbPic, and FilteredCrPic are arrays of output pixels of luma Y and chromas Cb and Cr subjected to filter processing, respectively. A top left pixel position of a patch of pixels including the vertical pixel coordinate cTop and the horizontal pixel coordinate cLeft is used. In a case that nnpfc_purpose is equal to 2 or 4 in the input tensor, nnpfc_out_order_idc is not equal to 3. A value of nnpfc_out_order_idc is a value from 0 to 255. The value of nnpfc_out_order_idc greater than 3 is reserved for future indication, and thus is not present in a bitstream conforming to the version of this specification. A decoder conforming to the specification of this version ignores the SEI message including such a reserved value of nnpfc_out_order_idc.

In a case that the value of nnpfc_out_order_idc is 0, only a luma matrix is present in the output tensor, and thus the number of channels is 1. From the output tensors of the vertical pixel coordinate cTop and the horizontal pixel coordinate cLeft, a process StoreOutputTensors() for deriving the pixel value of the output pixel array FilteredYPic subjected to filter processing is as follows.

```
for(yP=0;yP<outPatchHeight;yP++)
  for(xP=0;xP<outPatchWidth;xP++) {
    yY=cTop*outPatchHeight/inpPatchHeight+yP
    xY=cLeft*outPatchWidth/inpPatchWidth+xP
    if(yY<nnpfc_pic_height_in_luma_samples &&
        xY<nnpfc_pic_width_in_luma_samples)
      if(nnpfc_component_last_flag==0)
        FilteredYPic[yY][xY]=OutY(outputTensor[0][0][yP][xP])
      else
        FilteredYPic[yY][xY]=OutY(outputTensor[0][yP][xP][0])
  }
```

In a case that the value of nnpfc_out_order_idc is 1, only a chroma matrix is present in the output tensor, and thus the number of channels is 2. From the output tensors of the vertical pixel coordinate cTop and the horizontal pixel coordinate cLeft, the process StoreOutputTensors() for deriving the pixel values of the output pixel arrays FilteredCbPic and FilteredCrPic subjected to filter processing is as follows.

```
for(yP=0;yP<outPatchCHeight;yP++)
  for(xP=0;xP<outPatchCWidth;xP++) {
    xSrc=cLeft*horCScaling+xP
    ySrc=cTop*verCScaling+yP
    if(ySrc<nnpfc_pic_height_in_luma_samples/outSubHeightC &&
        xSrc<nnpfc_pic_width_in_luma_samples/outSubWidthC)
      if(nnpfc_component_last_flag==0) {
        FilteredCbPic[ySrc][xSrc]=OutC(outputTensor[0][0][yP][xP])
        FilteredCrPic[ySrc][xSrc]=OutC(outputTensor[0][1][yP][xP])
      }else{
        FilteredCbPic[ySrc][xSrc]=OutC(outputTensor[0][yP][xP][0])
        FilteredCrPic[ySrc][xSrc]=OutC(outputTensor[0][yP][xP][1])
      }
  }
```

In a case that the value of nnpfc_out_order_idc is 2, a luma matrix and a chroma matrix are present in the output tensor, and thus the number of channels is 3. From the output tensors of the vertical pixel coordinate cTop and the horizontal pixel coordinate cLeft, the process StoreOutputTensors() for deriving the pixel values of the output pixel arrays FilteredYPic, FilteredCbPic, and FilteredCrPic subjected to filter processing is as follows.

```
for(yP=0;yP<outPatchHeight;yP++)
  for(xP=0;xP<outPatchWidth;xP++) {
    yY=cTop*outPatchHeight/inpPatchHeight+yP
    xY=cLeft*outPatchWidth/inpPatchWidth+xP
    yC=yY/outSubHeightC
    xC=xY/outSubWidthC
    yPc=(yP/outSubHeightC)*outSubHeightC
    xPc=(xP/outSubWidthC)*outSubWidthC
    if(yY<nnpfc_pic_height_in_luma_samples
        && xY<nnpfc_pic_width_in_luma_samples)
      if(nnpfc_component_last_flag==0) {
        FilteredYPic[yY][xY]=OutY(outputTensor[0][0][yP][xP])
        FilteredCbPic[yC][xC]=OutC(outputTensor[0][1][yPc][xPc])
        FilteredCrPic[yC][xC]=OutC(outputTensor[0][2][yPc][xPc])
      }else{
        FilteredYPic[yY][xY]=OutY(outputTensor[0][yP][xP][0])
        FilteredCbPic[yC][xC]=OutC(outputTensor[0][yPc][xPc][1])
        FilteredCrPic[yC][xC]=OutC(outputTensor[0][yPc][xPc][2])
      }
  }
```

In a case that the value of nnpfc_out_order_idc is 3, four luma matrices and two chroma matrices are present in the output tensor, and thus the number of channels is 6. nnpfc_out_order_idc can be used only in a case that the chroma format is 4:2:0. From the output tensors of the vertical pixel coordinate cTop and the horizontal pixel coordinate cLeft, the process StoreOutputTensors() for deriving the pixel values of the output pixel arrays FilteredYPic, FilteredCbPic, and FilteredCrPic subjected to filter processing is as follows.

```
for(yP=0;yP<outPatchHeight;yP++)
  for(xP=0;xP<outPatchWidth;xP++) {
    ySrc=cTop/2*outPatchHeight/inpPatchHeight+yP
    xSrc=cLeft/2*outPatchWidth/inpPatchWidth+xP
    if(ySrc<nnpfc_pic_height_in_luma_samples/2&&
        xSrc<nnpfc_pic_width_in_luma_samples/2)
      if(nnpfc_component_last_flag==0) {
        FilteredYPic[ySrc*2][xSrc*2]=OutY(outputTensor[0][0][yP][xP])
        FilteredYPic[ySrc*2][xSrc*2+1]=OutY(outputTensor[0][1][yP][xP])
        FilteredYPic[ySrc*2+1][xSrc*2]=OutY(outputTensor[0][2][yP][xP])
        FilteredYPic[ySrc*2+1][xSrc*2+1]=OutY(outputTensor[0][3][yP][xP])
        FilteredCbPic[ySrc][xSrc]=OutC(outputTensor[0][4][yP][xP])
        FilteredCrPic[ySrc][xSrc]=OutC(outputTensor[0][5][yP][xP])
      }else{
        FilteredYPic[ySrc*2][xSrc*2]=OutY(outputTensor[0][yP][xP][0])
        FilteredYPic[ySrc*2][xSrc*2+1]=OutY(outputTensor[0][yP][xP][1])
        FilteredYPic[ySrc*2+1][xSrc*2]=OutY(outputTensor[0][yP][xP][2])
        FilteredYPic[ySrc*2+1][xSrc*2+1]=OutY(outputTensor[0][yP][xP][3])
        FilteredCbPic[ySrc][xSrc]=OutC(outputTensor[0][yP][xP][4])
        FilteredCrPic[ySrc][xSrc]=OutC(outputTensor[0][yP][xP][5])
      }
  }
```

Basic post-filtering processing for the decoded image is a filter that has a specific nnpfc_id value in the CLVS and is identified with a first neural network post-filter characteristics SEI message in decoding order.

Basic post-filtering processing that has the same nnpfc_id value and that is with another neural network post-filter characteristics SEI message having a value of nnpfc_mode_idc equal to 1 present is updated by decoding the bitstream of ISO/IEC 15938-17 in the neural network post-filter characteristics SEI message.

Otherwise, post-filtering processing PostProcessingFilter() is assigned so as to be the same as the basic post-filtering processing.

Depending on the value of nnpfc_out_order_idc, the decoded image is subjected to filtering processing with the post-filtering processing PostProcessingFilter() as shown below, and the pixel arrays FilteredYPic, FilteredCbPic, and FilteredCrPic for Y, Cb, and Cr are thereby generated.

The post-filtering processing PostProcessingFilter() of the decoded image is as follows.

```
if(nnpfc_inp_order_idc==0)
  for(cTop=0;cTop<InpPicHeightInLumaSamples;cTop+=inpPatchHeight)
    for(cLeft=0;cLeft<InpPicWidthInLumaSamples;cLeft+=inpPatchWidth) {
      DeriveInputTensors( )
      outputTensor=PostProcessingFilter(inputTensor)
      StoreOutputTensors( )
    }
else if(nnpfc_inp_order_idc==1)
  for(cTop=0;cTop<InpPicHeightInLumaSamples/InpSubHeightC;
      cTop+=inpPatchHeight)
    for(cLeft=0;cLeft<InpPicWidthInLumaSamples/InpSubWidthC;
        cLeft+=inpPatchWidth) {
      DeriveInputTensors( )
      outputTensor=PostProcessingFilter(inputTensor)
      StoreOutputTensors( )
    }
else if(nnpfc_inp_order_idc==2)
  for(cTop=0;cTop<InpPicHeightInLumaSamples;cTop+=inpPatchHeight)
    for(cLeft=0;cLeft<InpPicWidthInLumaSamples;cLeft+=inpPatchWidth) {
      DeriveInputTensors( )
      outputTensor=PostProcessingFilter(inputTensor)
      StoreOutputTensors( )
    }
else if(nnpfc_inp_order_idc==3)
  for(cTop=0;cTop<InpPicHeightInLumaSamples;cTop+=inpPatchHeight*2)
    for(cLeft=0;cLeft<InpPicWidthInLumaSamples;cLeft+=inpPatchWidth*2) {
      DeriveInputTensors( )
      outputTensor=PostProcessingFilter(inputTensor)
      StoreOutputTensors( )
    }
```

In a case that neural network post-filter characteristics SEI messages having the same nnpfc_id but having different contents are present in the same image unit, both of the neural network post-filter characteristics SEI messages are present in the same SEI NAL unit.

In a case that these SEI messages indicate a neural network that can be used as the post-filtering processing, in semantics, as indicated by the value of nnpfc_out_order_idc including the output of the post-filtering processing, derivation of the luma pixel array FilteredYPic and the chroma pixel arrays FilteredCbPic and FilteredCrPic is indicated.

A syntax element nnpfc_reserved_zero_bit is equal to 0.

The syntax element nnpfc_payload_byte[i] includes an i-th byte of the bitstream conforming to ISO/IEC 15938-17. nnpfc_payload_byte[i] is all a bitstream completely conforming to ISO/IEC 15938-17.

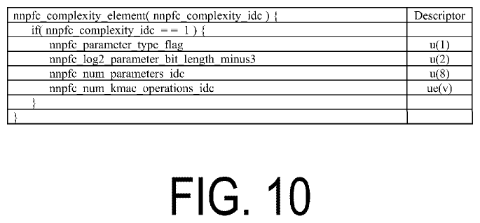

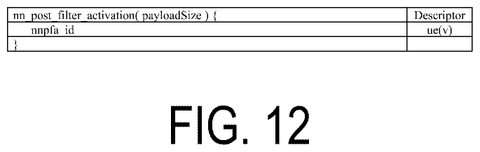

FIG. 10 illustrates syntax of a neural network complexity element nnpfc_complexity_element (nnpfc_complexity_idc) according to NPL 1. nnpfc_complexity_idc being an argument is a value indicating that there may be a syntax element indicating complexity of neural network post-filtering processing associated with nnpfc_id. nnpfc_id includes an identification number that can be used for identifying the post-filtering processing. nnpfc_complexity_element (nnpfc_complexity_idc) is called from the neural network post-filter characteristics SEI message illustrated in FIG. 9. The neural network post-filter characteristics SEI message indicates the neural network that can be used as the post-filtering processing. Use of the post-filtering processing indicated for a specific image is indicated by the neural network post-filter activation SEI message illustrated in FIG. 12.

The syntax element nnpfc_complexity_element (nnpfc_complexity_idc) according to NPL 1 in FIG. 10 will be described below.

In a case that a value of a syntax element nnpfc_parameter_type_flag is 0, it is indicated that the neural network uses only an integer parameter. nnpfc_parameter_type_flag being equal to 1 indicates that the neural network can use a floating-point parameter or an integer parameter.

In a case that a value of a syntax element nnpfc_log2_parameter_bit_length_minus3 is 1, 2, or 3, it is indicated that the neural network does not use a parameter of the bit-depth larger than 8 bits, 16 bits, 32 bits, or 64 bits, respectively.

A syntax element nnpfc_num_parameters_idc indicates a maximum number of a neural network parameter of the post-filtering processing in a unit of powers of 2048. nnpfc_num_parameters_idc being equal to 0 indicates that the maximum number of the neural network parameter is not indicated. In a case that a value of nnpfc_num_parameters_idc is greater than zero, a variable maxNumParameters is derived as follows.

maxNumParameters=(2048«nnpfc_num_parameters_idc)−1

The requirement for bitstream conformance is that the number of neural network parameters of the post-filtering processing is maxNumParameters or less.

A syntax element nnpfc_num_kmac_operations_idc is a syntax element indicating a maximum of product-sum operation per pixel in the post-filtering processing. In a case that a value of nnpfc_num_kmac_operations_idc is greater than 0, it is indicated that the maximum number of the product-sum operation per pixel in the post-filtering processing is nnpfc_num_kmac_operations_idc*1000 or less. In a case that the value of nnpfc_num_kmac_operations_idc is 0, it is indicated that the maximum number of the product-sum operation in the network is not indicated.

In the specification of the neural network post-filter characteristics SEI according to NPL 1, there is a problem that the variable maxNumParameters indicating the maximum value of the network parameter may overflow with a value of a 32-bit integer or a 64-bit integer.

nnpfc_num_parameters_idc is defined with u(8), that is, 8 bits of a binary number, and can have a value from 0 to 255. With use of the syntax element, the maximum number of the neural network parameter of the post-filtering processing is indicated in a unit of powers of 2048, and thus up to a maximum of ((2048«255)−1) can be expressed. However, the value greatly exceeds a range of a value of a 32-bit integer or a 64-bit integer being an integer expression method in general hardware and software.

In view of this, in a case that the variable maxNumParameters is an unsigned 32-bit integer, in order to prevent overflow in calculation being performed, maxNumParameters satisfies the following: maxNumParameters=(2048«20)−1 or less. Accordingly, the range of the value of nnpfc_num_parameters_idc is set equal to 0 to 20, with Description being set equal to u(5). Alternatively, in a case that the variable maxNumParameters is an unsigned 64-bit integer, in order to prevent overflow in calculation being performed, maxNumParameters satisfies the following: maxNumParameters=(2048«52)−1 or less. Accordingly, the range of the value of nnpfc_num_parameters_idc is set equal to 0 to 52, with Description being set equal to u(6). Here, u(x) indicates that syntax is an unsigned integer and binarization employs a fixed-length of x bits. In other words, it indicates that the range of the value is 0 to (1«x)−1.

Alternatively, in a case that the variable maxNumParameters is an unsigned 16-bit integer, in order to prevent overflow in calculation being performed, maxNumParameters satisfies the following: maxNumParameters=(2048«4)−1 or less. Accordingly, the range of the value of nnpfc_num_parameters_idc is set equal to 0 to 4, using the binarization indicated by Description being set equal to u(3).

In a case that the variable maxNumParameters is a signed 32-bit integer, in order to prevent overflow in calculation being performed, maxNumParameters satisfies the following: maxNumParameters=(2048«19)−1 or less. Accordingly, the range of the value of nnpfc_num_parameters_idc is set equal to 0 to 19, using the binarization with Description being set equal to u(5).

Alternatively, in a case that the variable maxNumParameters is a signed 64-bit integer, in order to prevent overflow in calculation being performed, maxNumParameters satisfies the following: maxNumParameters=(2048«51)−1 or less. Accordingly, the range of the value of nnpfc_num_parameters_idc is set equal to 0 to 51, using the binarization with Description being set equal to u(6). Alternatively, in a case that the variable maxNumParameters is a signed 16-bit integer, maxNumParameters satisfies the following: maxNumParameters=(2048«3)−1 or less. Accordingly, the range of the value of nnpfc_num_parameters_idc is set equal to 0 to 3, with Description being set equal to u(2).

Note that the value of 2048 is not restrictive, and the following values may be used.

maxNumParameters=1024«nnpfc_num_parameters_idc

nnpfc_num_parameters_idc is binarization of u(6).

maxNumParameters=512«nnpfc_num_parameters_idc

nnpfc_num_parameters_idc is binarization of u(7).

That is, the following expression may be used.

maxNumParameters=(1«N_UNIT)«nnpfc_num_parameters_idc

nnpfc_num_parameters_idc may be binarization of u(16−N_UNIT). N_UNIT is any integer from 0 to 11.

By setting a definition of the binarization as described above, the problem that the variable maxNumParameters indicating the maximum value of the network parameter may overflow can be solved.

In the embodiment described above, the maximum value of the network parameter is defined by shifting the value of 2048 used in NPL 1, and based on this presupposition, such a range of a value that prevents overflow of integer arithmetic is derived in derivation of the variable maxNumParameters. However, a similar method can be applied to values other than 2048.

As another solution, instead of the value of 2048, for example, the definition may be set using the following expression, with a syntax element nnpfc_num_parameters_base_value being added prior to nnpfc_num_parameters_idc of FIG. 9.

maxNumParameters=(nnpfc_num_parameters_base_value«nnpfc_num_parameters_idc)−1

Description of nnpfc_num_parameters_base_value is set equal to u(n), where n represents a natural number, and the variable maxNumParameters is an unsigned 32-bit integer. In a case that Description of nnpfc_num_parameters_idc is u(m), where m represents a natural number, the value of (n+m) may be set equal to 31 or less. In a case that the variable maxNumParameters is an unsigned 64-bit integer, the value of (n+m) may be set equal to 63 or less. In a case that the variable maxNumParameters is an unsigned 16-bit integer, the value of (n+m) may be set equal to 15 or less. In a case that the variable maxNumParameters is a signed 32-bit integer, the value of (n+m) may be set equal to 30 or less. In a case that the variable maxNumParameters is a signed 64-bit integer, the value of (n+m) may be set equal to 61 or less. In a case that the variable maxNumParameters is a signed 16-bit integer, the value of (n+m) may be set equal to 14 or less.

In the specification of the neural network post-filter characteristics SEI according to NPL 1, there is a problem that an upper value of nnpfc_num_kmac_operations_idc being a syntax element indicating the maximum of the product-sum operation per pixel in the post-filtering processing is not defined. Thus, there is a problem that an internal variable may overflow with a value of a 32-bit integer or a 64-bit integer, for example.

In view of this, the upper value of nnpfc_num_kmac_operations_idc is set equal to a range of the integer. For example, the upper value is set equal to two to the 32nd power−1, which is an upper value of unsigned 32-bit integer. The upper value may be set equal to two to the 64th power−1, which is an upper value of unsigned 64-bit integer. The upper value may be set equal to two to the 16th power−1, which is an upper value of unsigned 16-bit integer.

In a case that a signed integer is taken into consideration, the upper value may be set equal to two to the 31st power−1 which is an upper value of signed 32-bit integer, two to the 63rd power−1 which is an upper value of signed 64-bit integer, or two to the 15th power−1 which is an upper value of signed 16-bit integer. In any case, the upper value needs to be defined.

By setting a definition as described above, the problem that nnpfc_num_kmac_operations_idc being a syntax element indicating the maximum of the product-sum operation per pixel in the post-filtering processing may overflow can be solved.

### Neural Network Post-Filter Activation SEI

FIG. 12 is a diagram illustrating syntax of the neural network post-filter activation SEI message according to NPL 1.

This SEI message indicates the neural network post-filtering processing that can be used for the post-filtering processing of the current decoded image. The neural network post-filter activation SEI message is applied only to the current decoded image.

For example, there may be cases that multiple neural network post-filter activation SEI messages are present for the same decoded image, such as a case that the post-filtering processing has a variety of purposes and a case that a variety of color components are subjected to the filtering processing.

A syntax element nnpfa_id indicates that the neural network post-filtering processing indicated by one or more pieces of neural network post-filter characteristics SEI that pertain to the current decoded image and have nnpfc_id equal to nnfpa_id can be used for the post-filtering processing of the current decoded image.

In NPL 1, the neural network post-filter characteristics SEI is SEI applied to each CVS, and the neural network post-filter activation SEI is, although being applied to each decoded image, not able to support changing of the width, the height, and the quantization parameter of the decoded image for each decoded image, which poses a problem.

In view of this, in the neural network post-filter activation SEI, regarding the neural network post-filtering processing used for the post-filtering processing of the current picture, with the index nnfpa_id of the SEI that indicates information of the post-filtering processing, not only the neural network post-filter characteristics SEI is identified, but also the width, the height, and the quantization parameter of the current decoded image used in that case are indicated.

Specifically, the variable InpPicWidthInLumaSamples is set equal to pps_pic_width_in_luma_samples-SubWidthC*(pps_conf_win_left_offset+pps_conf win_right_offset) of the current decoded image. The variable InpPicHeightInLumaSamples is set equal to pps_pic_height_in_luma_samples-SubHeightC*(pps_conf_win_top_offset+pps_conf win_bottom_offset) of the current decoded image.

The current decoded image has two-dimensional array CroppedYPic[y][x] of a luma pixel and two-dimensional array CroppedCbPic[y][x] and CroppedCrPic[y][x] of a chroma pixel having a vertical coordinate y and a horizontal coordinate x. Here, the coordinates (x, y) of a top left corner of the pixel array are (0, 0).

The decoded image has a luma pixel bit-depth BitDepthY. The decoded image has a chroma pixel bit-depth BitDepthC. Note that both of BitDepthY and BitDepthC are set equal to BitDepth.

A variable InpSubWidthC represents a chroma sub-sampling ratio for luminance in the horizontal direction of the decoded image, and a variable InpSubHeightC represents a chroma sub-sampling ratio for luminance in the horizontal direction of the decoded image. Note that InpSubWidthC is set equal to the variable SubWidthC of coded data. InpSubHeightC is set equal to the variable SubHeightC of coded data.

A variable SliceQPY is set equal to the quantization parameter SliceQpY of coded data updated at a slice level. The SliceQPY in this case is a quantization parameter of a first slice in the decoded image.

As described above, in the neural network post-filter activation SEI, by updating the value input to the neural network post-filter characteristics SEI with use of information of the current decoded image, appropriate post-filtering processing is enabled, and the problem is thereby solved.

### SEI Payload

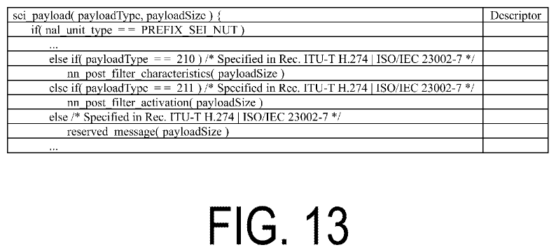

FIG. 13 is a diagram illustrating syntax of an SEI payload being a container of the SEI message according to NPL 1.

Each SEI is called in a case that nal_unit_type is PREFIX_SEI_NUT. PREFIX_SEI_NUT indicates that SEI is SEI located before slice data.

In a case that payloadType is 210, the neural network post-filter characteristics SEI is called.

In a case that payloadType is 211, the neural network post-filter activation SEI is called.

### Decoding of SEI and Post-Filtering Processing

The header decoder 3020 reads the SEI payload being a container of the SEI message, and decodes the neural network post-filter characteristics SEI message.

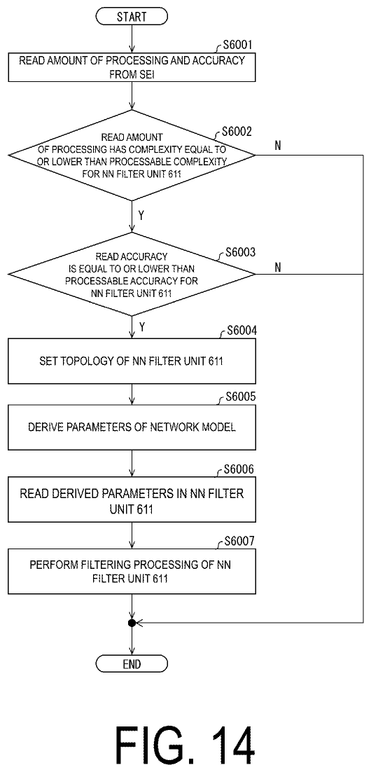

FIG. 14 is a diagram illustrating a flowchart of processing of the NN filter unit 611. The NN filter unit 611 performs the following processing in accordance with parameters of the SEI message.

S6001: Read the amount of processing and accuracy from a neural network complexity element.

S6002: End in a case that the complexity exceeds a complexity processable by the NN filter unit 611. Otherwise, proceed to S6003.

S6003: End in a case that the accuracy exceeds an accuracy processable by the NN filter unit 611. Otherwise, proceed to S6004.

S6004: Identify a network model from the SEI, and set topology of the NN filter unit 611.

S6005: Derive the parameters of the network model from update information of the SEI.

S6006: Read the derived parameters of the network model in the NN filter unit 611.

S6007: Perform filtering processing of the NN filter unit 611, and output to the outside.

Note that the SEI is not necessarily required for construction of a luma sample and a chroma sample in decoding processing.

### Configuration Example of NN Filter Unit 611

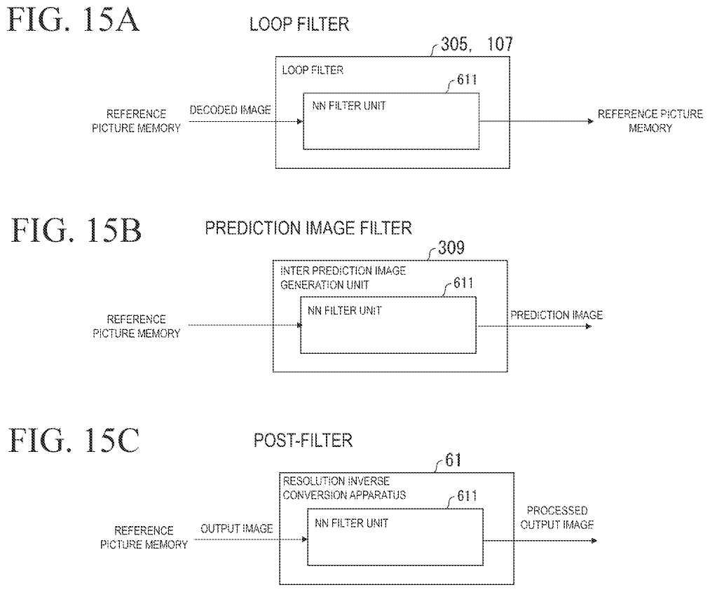

FIGS. 15A, 15B and 15C are diagrams illustrating configuration examples of an interpolation filter, a loop filter, and a post-filter using a neural network filter unit (NN filter unit 611). Although the following description will take an example of the post-filter, the interpolation filter or the loop filter may be used.

The resolution inverse conversion apparatus 61 after the video decoding apparatus includes the NN filter unit 611. In outputting an image in the reference picture memory 306, the NN filter unit 611 performs the filtering processing and outputs the image to the outside. The NN filter unit 611 may perform displaying, file writing, re-encoding (transcoding), transmission, and the like for the output image. The NN filter unit 611 is a means for performing the filtering processing by the neural network model on the input image. Simultaneously, the NN filter unit 611 may reduce or enlarge the size to an actual size or to a size of a multiple of a rational number.

Here, the neural network model (hereinafter an NN model) signifies elements and a connection relationship (topology) of the neural network and parameters (weight and bias) of the neural network. Note that only the parameters of the neural network model may be switched with the topology being fixed.

### Details of NN Filter Unit 611

The NN filter unit performs the filtering processing by the neural network model, using an input image inputTensor and input parameters (for example, QP, bS, and the like). The input image may be an image for each component, or may be an image having multiple components as channels. The input parameters may be assigned to a different channel from the image.

The NN filter unit may repeatedly apply the following processing.

The NN filter unit performs convolution operation (conv, convolution) of a kernel k[m][i][j] on inputTensor, and derives an output image outputTensor to which bias is added. Here, nn=0 n−1, xx=0 . . . width−1, and yy=0 . . . height−1, and Σ represents the sum for each of mm, i, and j.)

outputTensor[nn][yy]=ΣΣΣ(k[mm][i][j]*inputTensor[mm][xx+i−of][yy+j−of]+bias[nn])

In a case of 1×1 Conv, Σ represents the sum for each of mm=0 . . . m−1, i=0, and j=0. In this case, of=0 is set. In a case of 3×3 Conv, Σ represents the sum for each of mm=0 . . . m−1, i=0 . . . 2, and j=0 . . . 2. In this case, of=1 is set. n represents the number of channels of outSamples, m represents the number of channels of inputTensor, width represents the width of inputTensor and outputTensor, and height represents the height of inputTensor and outputTensor. of represents the size of a padding area provided around inputTensor in order to make inputTensor and outputTensor have the same size. In the following, in a case that output of the NN filter unit is a value (correction value) instead of an image, corrNN is used to represent output instead of outputTensor.

Note that, in a case of description using inputTensor and outputTensor of the CHW format instead of inputTensor and outputTensor of the CWH format, it is equivalent to the following processing.

outputTensor[nn][yy][xx]=ΣΣΣ(k[mm][i][j]*inputTensor[mm][yy+j−of][xx+i−of]+bias[nn])

Processing shown by the following expression referred to as Depth wise Conv may be performed. Here, nn=0 . . . n−1, xx=0 . . . width−1, and yy=0 . . . height−1, and Σ represents the sum for each of i and j. n represents the number of channels of outputTensor and inputTensor, width represents the width of inputTensor and outputTensor, and height represents the height of inputTensor and outputTensor.

outputTensor[nn][xx][yy]=ΣΣ(d[nn][l][j]*inputTensor[nn][xx+i−of][yy+j−of]+bias[nn])

Non-linear processing referred to as Activate, such as ReLU, may be used.

ReLU(x)=x>=0?x:0

leakyReLU shown in the following expression may be used.

leakyReLU(x)=x>=0?x:a*x

Here, a is a prescribed value, for example, 0.1 or 0.125. In order to perform integer arithmetic, all of the above values of k, bias, and a may be integers, and right shifting may be performed after conv.

In ReLU, for values smaller than 0, 0 is invariably output, and for values equal to or greater than 0, an input value is directly output. In contrast, in leakyReLU, for values smaller than 0, linear processing is performed with a gradient being set equal to a. In ReLU, the gradient for values smaller than 0 disappears, and thus learning may not advance steadily. In leakyReLU, the gradient for values smaller than 0 remains, and thus the above problem is less easily caused. Of above leakyReLU(x), PReLU using a parameterized value of a may be used.

### NNR

Neural Network Coding and Representation (NNR) is international standard ISO/IEC 15938-17 for efficiently compressing a neural network (NN). Compressing a learned NN enables to enhance efficiency in storing and transmitting the NN.

In the following, an overview of coding and decoding processing of NNR will be described.

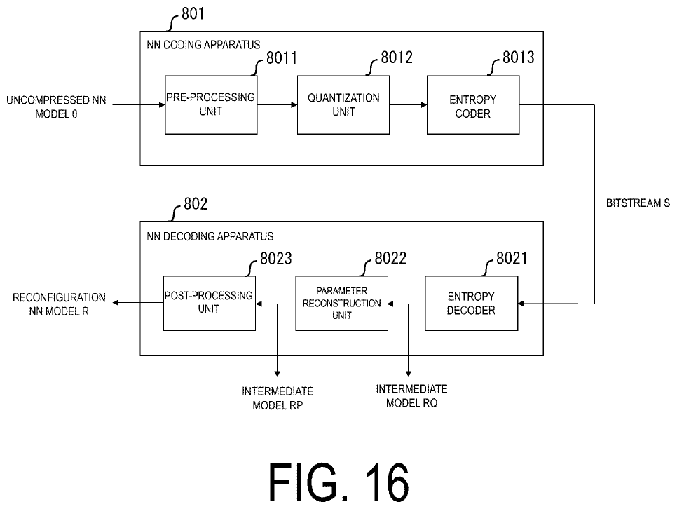

FIG. 16 is a diagram illustrating a coding apparatus and a decoding apparatus of NNR.

An NN coding apparatus 801 includes a pre-processing unit 8011, a quantization unit 8012, and an entropy coder 8013. The NN coding apparatus 801 inputs an uncompressed NN model 0, performs quantization of the NN model O in the quantization unit 8012, and derives a quantized model Q. Before the quantization, the NN coding apparatus 801 may repeatedly apply parameter reduction methods in the pre-processing unit 8011, such as pruning and sparse representation. Subsequently, in the entropy coder 8013, entropy coding is applied to the quantized model Q, and a bitstream S for storing and transmitting the NN model is derived.

An NN decoding apparatus 802 includes an entropy decoder 8021, a parameter reconstruction unit 8022, and a post-processing unit 8023. The NN decoding apparatus 802 first inputs the transmitted bitstream S, and in the entropy decoder 8021, performs entropy decoding of S and derives an intermediate model RQ. In a case that an operating environment of the NN model supports inference using a quantization representation used in RQ, RQ may be output and used for the inference. Otherwise, parameters of RQ are reconstructed to the original representation in the parameter reconstruction unit 8022, and an intermediate model

RP is derived. In a case that a sparse tensor representation to be used can be processed in the operating environment of the NN model, RP may be output and used for the inference. Otherwise, a tensor different from the NN model O or a reconfiguration NN model R not including a structural representation is derived and output.

In the NNR standard, there are decoding schemes for numerical representation of specific NN parameters, such as integers and floating points.

With a decoding scheme NNR_PT_INT, a model including a parameter of an integer value is decoded. With a decoding scheme NNR_PT_FLOAT, NNR_PT_INT is enhanced, and a quantization step size delta is added. delta is multiplied by the integer value, and a scaled integer is thereby generated. delta is derived as follows, using a quantization parameter qp of an integer and a granularity parameter qp_density of delta.

mul=2′(qp_density)+(qp&(2″(qp_density)−1))

delta=mul*2′((qp»qp_density)−qp_density)

### Format of Learned NN

Representation of a learned NN is made up of two elements, i.e., topology representation such as the size of each layer and connection between the layers and parameter representation such as the weight and the bias.

The topology representation is covered by native formats such as Tensorflow and PyTorch; however, for the sake of enhancement of interoperability, there are exchange formats such as an Open Neural Network Exchange Format (ONNX) and a Neural Network Exchange Format (NNEF).

In the NNR standard, topology information nnr_topology_unit_payload is transmitted as a part of an NNR bitstream including a compressed parameter tensor. This allows for implementation of interoperation with topology information represented not only in an exchange format but also in a native format.

### Configuration of Image Coding Apparatus

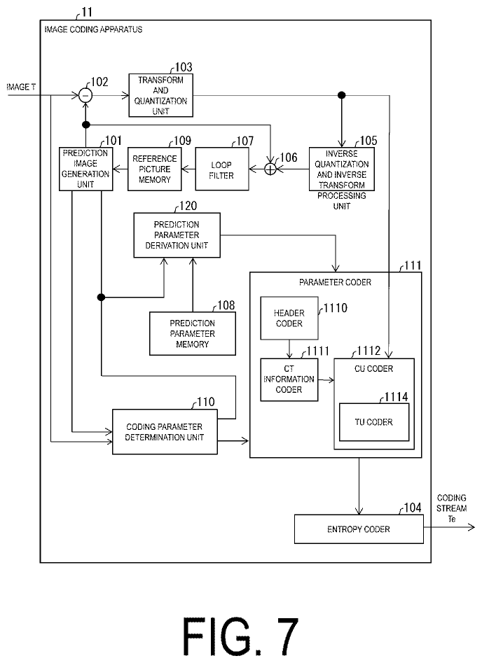

Next, a configuration of the image coding apparatus 11 according to the present embodiment will be described. FIG. 7 is a block diagram illustrating a configuration of the image coding apparatus 11 according to the present embodiment. The image coding apparatus 11 includes a prediction image generation unit 101, a subtraction unit 102, a transform and quantization unit 103, an inverse quantization and inverse transform processing unit 105, an addition unit 106, a loop filter 107, a prediction parameter memory (a prediction parameter storage unit, a frame memory) 108, a reference picture memory (a reference image storage unit, a frame memory) 109, a coding parameter determination unit 110, a parameter coder 111, a prediction parameter derivation unit 120, and an entropy coder 104.

The prediction image generation unit 101 generates a prediction image for each CU.

The subtraction unit 102 subtracts a pixel value of the prediction image of a block input from the prediction image generation unit 101 from a pixel value of the image T to generate a prediction error. The subtraction unit 102 outputs the prediction error to the transform and quantization unit 103.

The transform and quantization unit 103 performs a frequency transform on the prediction error input from the subtraction unit 102 to calculate a transform coefficient, and derives a quantization transform coefficient by quantization. The transform and quantization unit 103 outputs the quantization transform coefficient to the parameter coder 111 and the inverse quantization and inverse transform processing unit 105.

The inverse quantization and inverse transform processing unit 105 is the same as the inverse quantization and inverse transform processing unit 311 (FIG. 5) in the image decoding apparatus 31, and descriptions thereof are omitted. The calculated prediction error is output to the addition unit 106.

The parameter coder 111 includes a header coder 1110, a CT information coder 1111, and a CU coder 1112 (prediction mode coder). The CU coder 1112 further includes a TU coder 1114. General operation of each module will be described below.

The header coder 1110 performs coding processing of parameters such as header information, split information, prediction information, and quantization transform coefficients.

The CT information coder 1111 codes QT and MT (BT, TT) split information and the like.

The CU coder 1112 codes the CU information, the prediction information, the split information, and the like.

In a case that a prediction error is included in the TU, the TU coder 1114 codes the QP update information and the quantization prediction error.

The CT information coder 1111 and the CU coder 1112 supply syntax elements such as the inter prediction parameter and the quantization transform coefficients to the parameter coder 111.

The parameter coder 111 inputs the quantization transform coefficients and the coding parameters to the entropy coder 104. The entropy coder 104 performs entropy coding on these to generate the coded data Te, and outputs the generated coded data Te.

The prediction parameter derivation unit 120 derives the inter prediction parameter and the intra prediction parameter from the parameters input from the coding parameter determination unit 110. The inter prediction parameter and intra prediction parameter derived are output to the parameter coder 111.

The addition unit 106 adds the pixel value for the prediction block input from the prediction image generation unit 101 and the prediction error input from the inverse quantization and inverse transform processing unit 105 together for each pixel and generates a decoded image. The addition unit 106 stores the generated decoded image in the reference picture memory 109.

The loop filter 107 applies a deblocking filter, an SAO, and an ALF to the decoded image generated by the addition unit 106. Note that the loop filter 107 need not necessarily include the above-described three types of filters, and may have a configuration of only the deblocking filter, for example.

The prediction parameter memory 108 stores the prediction parameters generated by the coding parameter determination unit 110 for each target picture and CU at a predetermined position.

The reference picture memory 109 stores the decoded image generated by the loop filter 107 for each target picture and CU at a predetermined position.

The coding parameter determination unit 110 selects one set among multiple sets of coding parameters. The coding parameters include the above-described QT, BT, or TT split information, prediction parameters, or parameters to be coded which are generated in relation thereto. The prediction image generation unit 101 generates the prediction image by using these coding parameters.

Note that a computer may be used to implement a part of the image coding apparatus 11 and the image decoding apparatus 31 in the above-described embodiments, for example, the entropy decoder 301, the parameter decoder 302, the loop filter 305, the prediction image generation unit 308, the inverse quantization and inverse transform processing unit 311, the addition unit 312, the prediction parameter derivation unit 320, the prediction image generation unit 101, the subtraction unit 102, the transform and quantization unit 103, the entropy coder 104, the inverse quantization and inverse transform processing unit 105, the loop filter 107, the coding parameter determination unit 110, the parameter coder 111, and the prediction parameter derivation unit 120. In that case, this configuration may be realized by recording a program for realizing such control functions on a computer-readable recording medium and causing a computer system to read and perform the program recorded on the recording medium. Note that the “computer system” mentioned here refers to a computer system built into either the image coding apparatus 11 or the image decoding apparatus 31 and is assumed to include an OS and hardware components such as a peripheral apparatus. The “computer-readable recording medium” refers to a portable medium such as a flexible disk, a magneto-optical disk, a ROM, and a CD-ROM, and a storage device such as a hard disk built into the computer system. Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a fixed period of time, such as a volatile memory included in the computer system functioning as a server or a client in such a case. The above-described program may be one for realizing some of the above-described functions, and also may be one capable of realizing the above-described functions in combination with a program already recorded in the computer system.

Part or all of the image coding apparatus 11 and the image decoding apparatus 31 in the embodiments described above may be realized as an integrated circuit such as a Large Scale Integration (LSI). Each function block of the image coding apparatus 11 and the image decoding apparatus 31 may be individually realized as processors, or part or all thereof may be integrated into processors. The circuit integration technique is not limited to LSI, and a dedicated circuit or a multi-purpose processor may be used for realization. In a case that, with advances in semiconductor technology, a circuit integration technology with which an LSI is replaced appears, an integrated circuit based on the technology may be used.

The embodiment of the present invention has been described in detail above referring to the drawings, but the specific configuration is not limited to the above embodiment and various amendments and the like can be made to a design that fall within the scope that does not depart from the gist of the present invention.

The present embodiment is described with reference to FIG. 1 as follows. A video decoding apparatus is provided. The video decoding apparatus includes an image decoding apparatus configured to decode coded data to generate a decoded image, and a resolution inverse conversion apparatus configured to convert a resolution of the decoded image to a specified resolution by using inverse conversion information, the resolution inverse conversion apparatus using a neural network. In the resolution inverse conversion apparatus, information indicating the number of horizontal pixels and the number of vertical pixels of a patch size being a unit of processing of the neural network is decoded. The number of horizontal pixels and the number of vertical pixels of the decoded image are set equal to a maximum value of the number of horizontal pixels and a maximum value of the number of vertical pixels of the patch size, respectively.

A video decoding apparatus is provided. The video decoding apparatus includes an image decoding apparatus configured to decode coded data to generate a decoded image, and a resolution inverse conversion apparatus configured to convert a resolution of the decoded image to a specified resolution by using inverse conversion information, the resolution inverse conversion apparatus using a neural network. Information indicating a maximum value of a network parameter of the neural network in the resolution inverse conversion apparatus is decoded. In deriving the maximum value of the network parameter, the maximum value is derived so as to not overflow in 32-bit integer arithmetic.

A video coding apparatus is provided. The video coding apparatus includes an image coding apparatus configured to code an image to generate coded data, an inverse conversion information generation apparatus configured to generate inverse conversion information for inversely converting a resolution of a decoded image in a case that the coded data is decoded, and an inverse conversion information coding apparatus configured to code the inverse conversion information as supplemental enhancement information. In the resolution inverse conversion information coding apparatus, information indicating the number of horizontal pixels and the number of vertical pixels of a patch size being a unit of processing of a neural network is coded. The number of horizontal pixels and the number of vertical pixels of a coded image are set equal to a maximum value of the number of horizontal pixels and a maximum value of the number of vertical pixels of the patch size, respectively.

A video coding apparatus is provided. The video coding apparatus includes an image coding apparatus configured to code an image to generate coded data, an inverse conversion information generation apparatus configured to generate inverse conversion information for inversely converting a resolution of a decoded image in a case that the coded data is decoded, and an inverse conversion information coding apparatus configured to code the inverse conversion information as supplemental enhancement information. Information indicating a maximum value of a network parameter of a neural network in the resolution inverse conversion information coding apparatus is coded. In deriving the maximum value of the network parameter, the maximum value is derived so as to not overflow in 64-bit integer arithmetic.

The embodiment of the present invention is not limited to the above-described embodiment, and various modifications are possible within the scope of the claims. That is, an embodiment obtained by combining technical means modified appropriately within the scope of the claims is also included in the technical scope of the present invention.

### INDUSTRIAL APPLICABILITY

The embodiment of the present invention can be preferably applied to a video decoding apparatus that decodes coded data in which image data is coded, and a video coding apparatus that generates coded data in which image data is coded. The embodiment of the present invention can be preferably applied to a data structure of coded data generated by the video coding apparatus and referred to by the video decoding apparatus.

### REFERENCE SIGNS LIST

1 Video transmission system

30 Video decoding apparatus

31 Image decoding apparatus

301 Entropy decoder

302 Parameter decoder

305, 107 Loop filter

306, 109 Reference picture memory

307, 108 Prediction parameter memory

308, 101 Prediction image generation unit

311, 105 Inverse quantization and inverse transform processing unit

312, 106 Addition unit

320 Prediction parameter derivation unit

10 Video coding apparatus

11 Image coding apparatus

102 Subtraction unit

103 Transform and quantization unit

104 Entropy coder

110 Coding parameter determination unit

111 Parameter coder

120 Prediction parameter derivation unit

71 Inverse conversion information creation apparatus

81 Inverse conversion information coding apparatus

91 Inverse conversion information decoding apparatus

611 NN filter unit

1. A video decoding apparatus comprising:
an image decoding apparatus configured to decode coded data to generate a decoded image; and
a resolution inverse conversion apparatus configured to convert a resolution of the decoded image to a specified resolution by using inverse conversion information, the resolution inverse conversion apparatus using a neural network, wherein
in the resolution inverse conversion apparatus, information indicating the number of horizontal pixels and the number of vertical pixels of a patch size being a unit of processing of the neural network is decoded, and
the number of horizontal pixels and the number of vertical pixels of the decoded image are set equal to a maximum value of the number of horizontal pixels and a maximum value of the number of vertical pixels of the patch size, respectively.

2. A video decoding apparatus comprising:
an image decoding apparatus configured to decode coded data to generate a decoded image; and
a resolution inverse conversion apparatus configured to convert a resolution of the decoded image to a specified resolution by using inverse conversion information, the resolution inverse conversion apparatus using a neural network, wherein
information indicating a maximum value of a network parameter of the neural network in the resolution inverse conversion apparatus is decoded, and
in deriving the maximum value of the network parameter, the maximum value is derived so as to not overflow in 64-bit integer arithmetic.

3. A video coding apparatus comprising:
an image coding apparatus configured to code an image to generate coded data;
an inverse conversion information generation apparatus configured to generate inverse conversion information for inversely converting a resolution of a decoded image in a case that the coded data is decoded; and
an inverse conversion information coding apparatus configured to code the inverse conversion information as supplemental enhancement information, wherein
in the inverse conversion information coding apparatus, information indicating the number of horizontal pixels and the number of vertical pixels of a patch size being a unit of processing of a neural network is coded, and
the number of horizontal pixels and the number of vertical pixels of a coded image are set equal to a maximum value of the number of horizontal pixels and a maximum value of the number of vertical pixels of the patch size, respectively.

4. A video coding apparatus comprising:
an image coding apparatus configured to code an image to generate coded data;
an inverse conversion information generation apparatus configured to generate inverse conversion information for inversely converting a resolution of a decoded image in a case that the coded data is decoded; and
an inverse conversion information coding apparatus configured to code the inverse conversion information as supplemental enhancement information, wherein
information indicating a maximum value of a network parameter of a neural network in the inverse conversion information coding apparatus is coded, and
in deriving the maximum value of the network parameter, the maximum value is derived so as to not overflow in 64-bit integer arithmetic.
